(19) United States
(12) Patent Application Publication
(10) Pub. No.: US 2016/0207504 A1
(43) Pub. Date: Jul. 21, 2016

(54) WASHER INJECTOR

(71) Applicant: HONDA MOTOR CO., LTD., Tokyo (JP)

(72) Inventors: Takeshi Sasaki, Saitama (JP); Tatsuya Omaru, Saitama (JP); Taisuke Goto, Saitama (JP)

(21) Appl. No.: 14/997,791

(22) Filed: Jan. 18, 2016

(30) Foreign Application Priority Data
Jan. 20, 2015 (JP) 2015-008865
Jan. 20, 2015 (JP) 2015-008866

(51) Int. Cl. B60S 1/52

(52) U.S. Cl. CPC B60S 1/52

(57) ABSTRACT

An object of the present invention is to provide a washer injector capable of injecting an amount of washer fluid which can properly wipe a windshield glass even when viscosity is increased or decreased depending on temperature change of the washer fluid. The washer injector includes a washer nozzle for injecting the washer fluid to the windshield glass of a vehicle, a washer pump for supplying the washer fluid to the washer nozzle, a fluid temperature sensor as a detection unit for detecting a fluid temperature which is a temperature of the washer fluid, and a control unit for controlling a discharge pressure of the washer pump. The control unit is configured to control the discharge pressure of the washer pump to be higher when the fluid temperature detected by the fluid temperature sensor is low than when the fluid temperature is high.

### CROSS REFERENCE TO RELATED APPLICATIONS

This application claims the foreign priority benefit under Title 35, United States Code, §119 (a)-(d) of Japanese Patent Application No. 2015-008865, filed on Jan. 20, 2015, and Japanese Patent Application No. 2015-008866, filed on Jan. 20, 2015 in the Japan Patent Office, each disclosure of which is herein incorporated by reference in its entirety.

### TECHNICAL FIELD

The present invention relates to a washer injector for injecting a washer fluid to a windshield glass of a vehicle.

### BACKGROUND ART

As a device for injecting the washer fluid to the windshield glass of the vehicle, the devices described in Patent Documents 1 and 2 are disclosed. The device described in Patent Document 1 is provided with a temperature sensor for detecting a surface temperature of the windshield glass, and automatically stops injection operation of the washer fluid when the temperature detected by the temperature sensor is equal to or lower than the freezing temperature of the washer fluid. With this configuration, the washer fluid is not injected even when a driver performs an injection operation of the washer fluid in cold weather where the temperature of the washer fluid is equal to or lower than the freezing temperature. Therefore, it is possible to prevent the washer fluid from freezing on the windshield glass to interfere with visibility of the driver.

The device described in Patent Document 2 is provided with a washer nozzle on a wiper arm thereof, and arcuately reciprocates the wiper arm by a wiper motor. In this case, the device injects the washer fluid to only a forward side during forward movement of the wiper arm, and injects the washer fluid to only a backward side during backward movement of the wiper arm. In this manner, it is possible to satisfactorily clean a wiped surface without interfering with visibility of the driver, and smoothly cleaning the wiped surface without applying an excessive load to the wiper motor.

### PRIOR ART DOCUMENTS

### Patent Literatures

[Patent Document 1]

Japanese examined Utility Model Application Publication No. H01-016686

[Patent Document 2]

Japanese examined Utility Model Application Publication No. H06-027482

### SUMMARY OF THE INVENTION

### Problem to be Solved by the Invention

Meanwhile, in the device described in Patent Document 1, it is assumed that an antifreeze washer fluid, which does not freeze even when it is equal to or lower than the freezing temperature of the washer fluid, is used. In this case, the antifreeze washer fluid does not freeze even when it is equal to or lower than the freezing temperature. However, when it is equal to or lower than the freezing temperature, the injection operation of the washer fluid is automatically stopped, and thus the washer fluid is not injected even when the above-described injection operation is performed. Therefore, the antifreeze washer fluid which is inherently available cannot be used.

As the temperature of the washer fluid is low, a kinetic viscosity thereof is increased, and thus the antifreeze washer fluid is difficult to flow through a flow path to the washer nozzle from a washer pump. In this case, when a discharge pressure of the washer pump remains the same, an amount of the washer fluid injected from the washer nozzle is reduced, to cause a problem of wiping performance degradation. In view of this problem, it is also conceivable to set the discharge pressure high from the beginning, however, in this case, since the viscosity is reduced as the temperature is increased beyond the freezing temperature, the washer fluid is excessively injected, resulting in excessive consumption of the washer fluid.

Further, in the device described in Patent Document 2, since the washer nozzle is provided on the wiper arm, height of the washer nozzle varies depending on a circular motion of the wiper arm. For example, the height of the washer nozzle is higher when the wiper arm is in a vertical state than when the wiper arm is in a horizontal state (see a washer nozzle 13 in FIG. 22). In this case, when the discharge pressure of the washer pump is constant, an injection amount of the washer fluid in the vertical state of the arm is smaller than that in the horizontal state of the arm, because a nozzle position in the vertical state of the arm is higher than that in the horizontal state of the arm.

That is, since the injection amount of the washer fluid is different depending on the height of the nozzle, there is a problem that an excess or deficiency occurs with respect to a desired injection amount. When the injection amount is insufficient, for example, cleaning performance of the windshield glass is degraded, and when the injection amount is excessive, for example, reduction of the washer fluid in a washer tank is rapid.

The present invention has been made in view of these circumstances, and an object thereof is to provide a washer injector capable of injecting an amount of washer fluid which can properly wipe the windshield glass even when the viscosity is increased or decreased depending on temperature change of the washer fluid.

Further, another object of the present invention is to provide a washer injector capable of injecting a predetermined amount of washer fluid regardless of height position of the washer nozzle provided on the wiper arm.

### Means to Solve the Problem

As a means for solving the above problems, the present invention according to claim 1 is an washer injector characterized by including a washer nozzle for injecting a washer fluid to a windshield glass of a vehicle, a washer pump for supplying the washer fluid to the washer nozzle, a detection unit for detecting a fluid temperature which is a temperature of the washer fluid, and a control unit for controlling a discharge pressure of the washer pump, wherein the control unit controls the discharge pressure of the washer pump to be higher when the fluid temperature detected by the detection unit is low than when the fluid temperature is high.

With this configuration, even when the temperature of the washer fluid is low and the viscosity thereof is increased, the discharge pressure of the washer pump (pump discharge pressure) is increased as the viscosity is increased, and thus it is possible to inject a required amount of washer fluid for properly wiping the windshield glass. In other words, it is possible to prevent wiping performance degradation.

Further, when the temperature of the washer fluid is high and the viscosity thereof is low, the pump discharge pressure is controlled to be low. In this control, the pump discharge pressure is low and the discharge amount is reduced, however, the discharge amount is more than that at low temperature because the viscosity is low and the washer fluid easily flows. Therefore, even when the pump discharge pressure is reduced, it is possible to inject the required amount of washer fluid for properly wiping the glass, as well as to prevent unnecessary consumption of the washer fluid.

That is, even when the viscosity is increased or decreased depending on temperature change of the washer fluid, it is possible to inject an amount of washer fluid capable of properly wiping the windshield glass so that the washer fluid is not excessively injected.

The present invention of claim 2 is the washer injector according to claim 1, characterized in that when the fluid temperature is equal to or lower than a predetermined threshold temperature, the control unit controls the discharge pressure of the washer pump to be higher than a discharge pressure at a time when the fluid temperature is higher than the threshold temperature.

With this configuration, it is possible to obtain the following operational effects. For example, the threshold temperature is defined as a temperature below zero (for example, −5° C.) at which an amount of washer fluid capable of properly wiping the glass cannot be injected. In this case, when the temperature of the washer fluid is equal to or lower than −5° C., the discharge pressure of the washer pump is increased to be higher than the discharge pressure at a time when the temperature of the washer fluid is higher than −5° C., and it is possible to increase the injection amount of the washer fluid to be an amount capable of properly wiping the windshield glass. In this manner, even when the temperature of the washer fluid is lowered to below zero, it is possible to increase the injection amount of the washer fluid to be the amount capable of properly wiping the windshield glass by a simple control.

The present invention according to claim 3 is a washer injector characterized by including a washer nozzle for injecting a washer fluid to a windshield glass of a vehicle, a washer pump for supplying the washer fluid to the washer nozzle, an obtaining unit for obtaining any one of an ambient temperature outside the vehicle, an engine temperature which is a temperature of an engine in an engine compartment of the vehicle, and a temperature in a vicinity of a flow path to the washer nozzle from a washer tank, and a control unit for controlling a discharge pressure of the washer pump, wherein the control unit controls the discharge pressure of the washer pump to be higher when the temperature obtained by the obtaining unit is low than when the temperature is high.

With this configuration, it is possible to obtain the following operational effects. Even when any one of the ambient temperature outside the vehicle, the engine temperature which is the temperature of the engine in the engine compartment of the vehicle, and the temperature in the vicinity of the flow path to the washer nozzle from the washer tank, is lowered and the temperature of the washer fluid is also lowered, and thus the viscosity is increased, it is possible to inject the required amount of washer fluid for properly wiping the glass, because the pump discharge pressure is increased as the viscosity is increased. In other words, it is possible to prevent the wiping performance degradation.

The present invention of claim 4 is the washer injector according to claim 3, characterized in that the obtaining unit obtains the ambient temperature, wherein when the obtained ambient temperature is equal to or lower than a specific ambient temperature which is set in advance, the control unit controls the discharge pressure of the washer pump to be higher than a discharge pressure at a time when the ambient temperature is higher than the specific ambient temperature.

With this configuration, since the pump discharge pressure is higher than the discharge pressure at the time when the ambient temperature is higher than the specific ambient temperature, it is possible to inject the amount of washer fluid capable of properly wiping the glass. Further, as the obtaining unit, an ambient temperature sensor which is used for controlling an air conditioner or the like mounted on the vehicle in advance, only have to be used, and thus it is possible to reduce the cost accordingly.

The present invention of claim 5 is the washer injector according to claim 4, characterized in that the obtaining unit obtains the ambient temperature and the engine temperature, wherein even when the obtained ambient temperature is equal to or lower than the specific ambient temperature, when the obtained engine temperature is equal to or higher than a specific engine temperature which is set in advance, the control unit controls the discharge pressure of the washer pump to be lower than a discharge pressure at a time when the engine temperature is lower than the specific engine temperature.

With this configuration, even when the ambient temperature of the vehicle is low, when the engine temperature is high, the washer fluid in the tank inside the engine compartment is warmed and the viscosity is low, and thus the washer fluid easily flows through the flow path. In this case, when the pump discharge pressure is reduced, the injection amount is reduced without impairing the proper wiping of the glass, and thus it is possible to prevent unnecessary consumption of the washer fluid. Further, as the obtaining unit, a sensor for detecting the engine temperature, engine coolant temperature, engine oil temperature, transmission oil temperature or the like, which is mounted on the vehicle in advance, only have to be used, and thus it is possible to reduce the cost accordingly.

The present invention of claim 6 is the washer injector according to claim 4, characterized in that the obtaining unit obtains the ambient temperature and the temperature in the vicinity of the flow path, wherein even when the obtained ambient temperature is equal to or lower than the specific ambient temperature, when the obtained temperature in the vicinity of the flow path is equal to or higher than a specific preset temperature in the vicinity of the flow path, the control unit controls the discharge pressure of the washer pump to be lower than a discharge pressure at a time when the temperature in the vicinity of the flow path is lower than the specific preset temperature in the vicinity of the flow path.

With this configuration, even when the ambient temperature of the vehicle is low, when the temperature in the vicinity of the flow path of the washer fluid is high, the washer fluid is warmed, the viscosity is low, and the washer fluid easily flows, and thus by reducing the pump discharge pressure the injection amount is reduced without impairing the proper wiping of the glass. This makes it possible to prevent unnecessary consumption of the washer fluid.

The present invention of claim 7 is the washer injector according to claim 1, characterized by further including a component detection unit for detecting components contained in the washer fluid, wherein, from a correspondence relationship between a viscosity and a temperature of the washer fluid containing components detected by the component detection unit, the control unit determines a viscosity of the washer fluid corresponding to a temperature detected during the detection, and corrects the discharge pressure of the washer pump to be a discharge pressure capable of discharging a required amount of washer fluid for properly wiping the windshield glass at a time of the determined viscosity.

With this configuration, since a change rate of increase or decrease of a kinetic viscosity of the washer fluid during temperature change is changed depending on the components of the washer fluid, it is possible to obtain the pump discharge pressure capable of injecting the washer fluid suitable for more proper wiping, by correcting the pump discharge pressure according to the components.

The present invention according to claim 8 is an washer injector characterized by including a wiper blade for wiping a windshield glass provided in a vehicle, a wiper arm for supporting the wiper blade, a drive mechanism including a motor for displacing the wiper arm at least in a vertical direction, a washer nozzle for injecting a washer fluid to the windshield glass, a washer pump for supplying the washer fluid to the washer nozzle, and a control unit for controlling a discharge pressure of the washer pump, wherein the washer nozzle is provided on the wiper blade or the wiper arm, and wherein the control unit controls the discharge pressure of the washer pump to be higher when a position of the wiper arm is high than when the position is low.

With this configuration, it is possible to increase the discharge pressure of the washer pump as height of the washer nozzle is high. Therefore, it is possible to inject a predetermined amount of washer fluid regardless of the height position of the washer nozzle provided on the wiper arm. This makes it possible to improve a wiping effect of the glass even when the nozzle is in a high position. Further, it is possible to avoid an increase and a decrease of the washer fluid due to the height position of the nozzle, by increasing the discharge pressure of the pump as the height of the nozzle is increased. Therefore, it is possible to reduce or prevent the wiping performance degradation and unnecessary consumption of the washer fluid.

The present invention of claim 9 is the washer injector according to claim 8, characterized in that when the control unit controls the discharge pressure of the washer pump to be higher when the position of the wiper arm is high than when the position is low, the control unit controls an injection amount of the washer fluid, which is injected from the washer nozzle, to be a constant amount in the same direction as reciprocating movement of the wiper arm.

With this configuration, it is possible to allow the injection amount of the washer fluid to be the constant amount regardless of the height of the nozzle. Therefore, when the constant injection amount of the washer fluid is defined as a minimum amount required for properly wiping the glass, it is possible to reduce or prevent unnecessary consumption of the washer fluid while improving the wiping performance of the glass.

The present invention of claim 10 is the washer injector according to claim 8, characterized in that the washer nozzle includes a forward side nozzle for injecting the washer fluid during forward movement of the wiper arm and a backward side nozzle for injecting the washer fluid during backward movement of the wiper arm, wherein the control unit controls the discharge pressure of the washer pump to be higher during the forward movement of the wiper arm than during the backward movement of the wiper arm.

With this configuration, the washer fluid is injected upward during the forward movement of the wiper arm, however, since the discharge pressure of the pump is increased to be higher than that during the backward movement, it is possible to inject a proper injection amount of washer fluid to a proper position where the wiping performance of the glass is not degraded. This makes it possible to improve the wiping effect of the glass even during the forward movement of the arm. Further, the discharge pressure is lower during the backward movement than during the forward movement, however, since the washer fluid is injected downward, it is possible to inject a required amount of washer fluid to a position where the wiping performance is not degraded. Therefore, it is possible to reduce or prevent the wiping performance degradation during the forward movement and unnecessary consumption of the washer fluid during the backward movement.

The present invention of claim 11 is the washer injector according to claim 8, characterized by further comprising a detection unit for detecting viscosity of the washer fluid, wherein the control unit controls the discharge pressure of the washer pump to be higher when the viscosity detected by the detection unit is high than when the viscosity is low.

With this configuration, it is possible to obtain optimum discharge pressure according to a level of the viscosity of the washer fluid. That is, when the viscosity of the washer fluid is high, the washer fluid is difficult to flow, however, it is possible to inject a proper amount of washer fluid to the glass by increasing the discharge pressure of the pump. This makes it possible to reduce or prevent the wiping performance degradation. Meanwhile, when the viscosity of the washer fluid is low, the washer fluid properly flows to the nozzle from the tank and is injected, even when the discharge pressure of the pump is low. Therefore, when the viscosity of the washer fluid is low, by reducing the discharge pressure of the pump it is possible to reduce or prevent unnecessary consumption of the washer fluid, and further it is possible to reduce driving electric power of the pump.

The present invention of claim 12 is the washer injector according to claim 8, characterized in that the control unit controls the discharge pressure of the washer pump to be gradually reduced in a position range of the wiper arm just before the washer fluid injected from the washer nozzle flies out to the outside of the windshield glass.

With this configuration, it is possible to properly wipe the glass while reducing waste of the washer fluid flying out to the outside of the glass.

The present invention of claim 13 is the washer injector according to claim 8, characterized in that the control unit controls the discharge pressure of the washer pump so that the washer fluid injected from the washer nozzle is stopped at a start position and an end position of reciprocating movement of the wiper arm.

With this configuration, it is possible to reduce waste of the washer fluid.

### Advantageous Effects of Invention

According to a washer injector of the present invention, it is possible to inject an amount of washer fluid capable of properly wiping a windshield glass even when a viscosity of the washer fluid is increased or decreased depending on temperature change of the washer fluid. Further, it is possible to inject a predetermined amount of washer fluid regardless of height position of the washer nozzle provided on the wiper arm.

### BRIEF DESCRIPTION OF THE DRAWINGS

FIG. 1 is a perspective view of a vehicle equipped with a washer injector according to a first embodiment of the present invention;

FIG. 2 is a block diagram showing a configuration of a control unit of the washer injector according to the first embodiment;

FIG. 3 is a fluid temperature and discharge pressure correspondence map showing a relationship between a temperature T of the washer fluid and a pump discharge pressure P;

FIG. 4A is a fluid temperature and viscosity correspondence map showing a relationship between the temperature T and a viscosity η of the washer fluid;

FIG. 4B is a viscosity and discharge pressure correspondence map showing a relationship between the viscosity η of the washer fluid and the pump discharge pressure P;

FIG. 5 is a flowchart for describing control of discharge pressure of a washer pump by the control unit of the washer injector according to the first embodiment;

FIG. 6 is a graph showing a relationship between the pump discharge pressure P and the fluid temperature T indicating a threshold temperature T0 for controlling the pump discharge pressure P according to a modification 1 of the first embodiment;

FIG. 7 is a perspective view showing a configuration of the vehicle further equipped with a component sensor in a washer tank according to a modification 2 of the first embodiment;

FIG. 8 is a block diagram showing a configuration of the control unit of the washer injector according to the modification 2 of the first embodiment;

FIG. 9 is a fluid temperature and viscosity correspondence map showing a relationship between the fluid temperature T and a kinetic viscosity ηv of the washer fluid according to the modification 2 of the first embodiment;

FIG. 10 is a viscosity and discharge pressure correspondence map showing a relationship between the kinetic viscosity ηv of the washer fluid and the pump discharge pressure P according to the modification 2 of the first embodiment;

FIG. 11 is a perspective view of a vehicle equipped with a washer injector according to a second embodiment of the present invention;

FIG. 12 is a block diagram showing a configuration of a control unit of the washer injector according to the second embodiment;

FIG. 13 is a graph showing a relationship between the temperature T of the washer fluid and an ambient temperature To according to the second embodiment;

FIG. 14 is a graph showing a relationship between the pump discharge pressure P and the ambient temperature To indicating a specific ambient temperature To1 for controlling the pump discharge pressure P according to the second embodiment;

FIG. 15 is a perspective view of a vehicle equipped with a washer injector according to a modification 1 of the second embodiment;

FIG. 16 is a block diagram showing a configuration of a control unit of the washer injector according to the modification 1 of the second embodiment;

FIG. 17 is a graph showing a relationship between the pump discharge pressure P and an engine temperature Te indicating a specific engine temperature Tel for controlling the pump discharge pressure P according to the modification 1 of the second embodiment;

FIG. 18 is a perspective view of a vehicle equipped with a washer injector according to a modification 2 of the second embodiment;

FIG. 19 is a block diagram showing a configuration of a control unit of the washer injector according to the modification 2 of the second embodiment;

FIG. 20 is a graph showing a relationship between the pump discharge pressure P and a temperature Tn in a vicinity of a flow path indicating a specific temperature Tn1 in the vicinity of the flow path for controlling the pump discharge pressure P according to the modification 2 of the second embodiment;

FIG. 21 is a perspective view of a vehicle equipped with a washer injector according to a third embodiment of the present invention;

FIG. 22A is a view showing a wiper arm, a wiper blade, and a washer nozzle, which are moving forward on a windshield glass;

FIG. 22B is a view showing the wiper arm, the wiper blade, and the washer nozzle, which are moving backward on the windshield glass;

FIG. 23 is a block diagram showing a configuration of a control unit of the washer injector according to the third embodiment of the present invention;

FIG. 24 is an angle and height correspondence map showing a relationship between an arm angle θ and a nozzle height H;

FIG. 25 is a height and discharge pressure correspondence map showing a relationship between the nozzle height H and a pump discharge pressure P;

FIG. 26 is a flowchart for describing control of the washer pump discharge pressure by the control unit of the washer injector according to the third embodiment;

FIG. 27 is a block diagram showing a control unit of a washer injector according to a fourth embodiment of the present invention;

FIG. 28 is a height and discharge pressure correspondence map showing a relationship between a nozzle height H and a pump discharge pressure P during forward and backward movement of the wiper arm according to the fourth embodiment;

FIG. 29 is a flowchart for describing control of the washer pump discharge pressure by the control unit of the washer injector according to the fourth embodiment;

FIG. 30 is a perspective view of a vehicle equipped with a washer injector according to a fifth embodiment of the present invention;

FIG. 31 is a block diagram showing a control unit of the washer injector according to the fifth embodiment;

FIG. 32 is a viscosity and correction value correspondence map showing a relationship between a viscosity η of the washer fluid and a correction value α according to the fifth embodiment; and

FIG. 33 is a view showing the wiper arm during reciprocating movement from a starting point position T10 to an end point position T13 on the windshield glass according to a modification 4.

### EMBODIMENTS FOR CARRYING OUT THE INVENTION

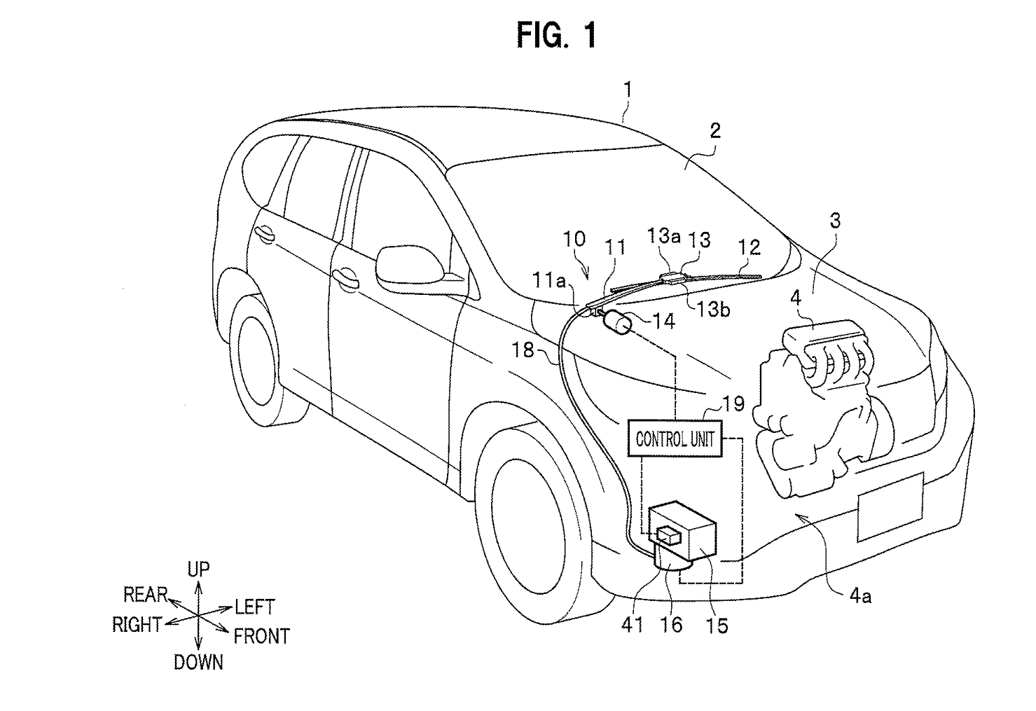

Embodiments of the present invention will be described in detail with reference to FIGS. 1 to 33. In the description, the same components are denoted by the same reference numerals, and duplicated description will be omitted. Further, when describing directions, they are described based on front, rear, left, right, up and down directions viewed from a driver (not shown) of a vehicle.

### Configuration of First Embodiment

FIG. 1 is a perspective view of a vehicle equipped with a washer injector according to a first embodiment of the present invention. As shown in FIG. 1, a washer injector 10 of a vehicle 1 is configured to include a wiper arm 11, a wiper blade 12, a washer nozzle 13, a wiper motor 14, a washer tank 15, a washer pump 16, a pipe 18 for connecting the washer nozzle 13 and the washer pump 16, a control unit (control means) 19, and a fluid temperature sensor (detection means) 41.

Note that, in some cases, the wiper arm 11 is abbreviated to the arm 11, the wiper blade 12 is abbreviated to blade 12, the washer nozzle 13 is abbreviated to the nozzle 13, the wiper motor 14 is abbreviated to the motor 14, the washer tank 15 is abbreviated to the tank 15, and the washer pump 16 is abbreviated to the pump 16.

The wiper motor 14 is a blushless motor or the like, and is disposed inside an engine hood 3 in front of a windshield glass 2 of the vehicle 1. The wiper motor 14 drives the wiper arm 11 to arcuately reciprocate around an axis in the vehicle front-rear direction of a rear end portion (referred to as a arm rear end portion) 11a of the wiper arm 11. The windshield glass 2 is a windshield glass described in claims, and is also simply referred to as a glass 2.

The wiper arm 11 has a rod shape, and is attached to a gear link mechanism or the like provided on a cowl top near the front right side of the glass 2, and a rod portion extending linearly from the arm rear portion 11a is disposed in a lateral direction on an outer surface of the glass 2. Further, the washer nozzle 13 is attached to a distal end portion of the wiper arm 11.

A shaft of the arm rear end portion 11a and a shaft of the wiper motor 14 are assembled through the gear link mechanism or the like (not shown). For example, although not shown, but as is well known, an assembly of the arm rear end portion 11a and the wiper motor 14 is configured such that the gear link mechanism is combined to the motor 14, a link rod (not shown) actuated by the gear link mechanism is provided, and the wiper arm 11 is connected to the link rod, so that the wiper arm 11 arcuately reciprocates. In addition, when the motor 14 is a stepping motor, the shaft of the motor 14 may be combined to the shaft of the arm rear end portion 11a through a joint member or the like.

The wiper blade 12 is made of an elastic material such as a rubber material having a narrow longitudinal shape. A middle portion of the longitudinal blade 12 is attached to the distal end portion of the wiper arm 11 through the washer nozzle 13. The attached state of the blade 12 is in the longitudinal direction of the arm 11. Further, the blade 12 repeats reciprocating movement so as to move arcuately forward in the left direction in FIG. 1 to a substantially vertical state (not shown) from a substantially horizontal state shown in FIG. 1, and then moves arcuately backward in the right direction in FIG. 1 to the substantially horizontal state, along with the arm 11 arcuately reciprocating in response to rotation of the motor 14. In this case, the washer nozzle 13 also reciprocates together with the blade 12.

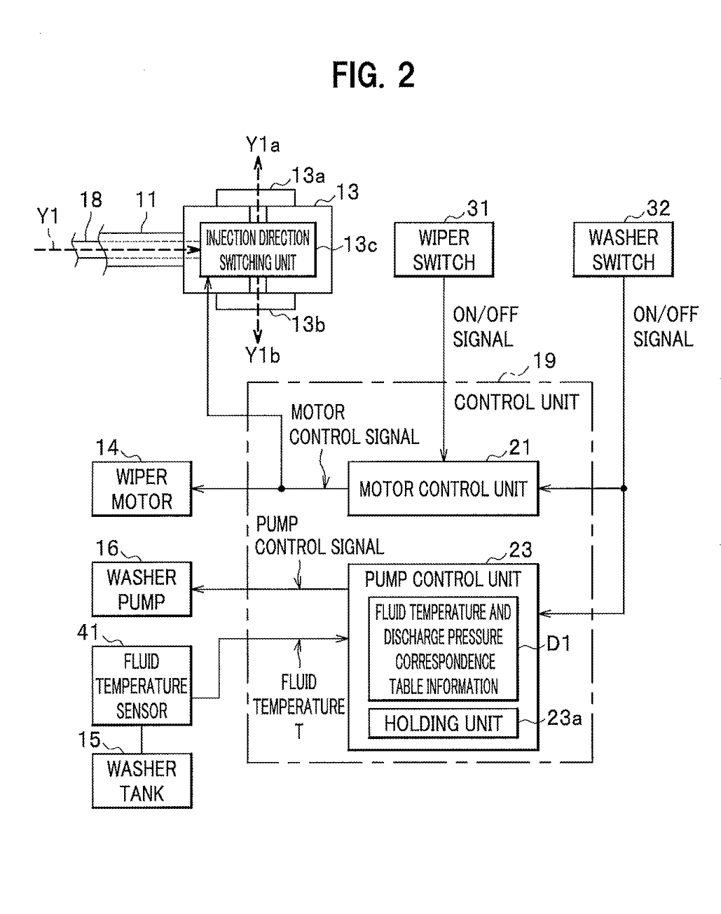

The washer nozzle 13 is fixed to the distal end portion of the wiper arm 11, and injects the washer fluid to the glass 2. The nozzle 13 has a forward side nozzle 13a and a backward side nozzle 13b. The forward side nozzle 13a injects the washer fluid to a forward moving direction when the arm 11 moves forward. The backward side nozzle 13b injects the washer fluid to a backward moving direction when the arm 11 moves backward. This switching of injection directions is performed by a control unit 19 (see FIG. 2) as described below.

The washer tank 15 is a tank for storing the washer fluid, the tank being made of a material such as a resin, and is disposed in a lower position of a right side wall in an engine compartment 4a in which an engine 4 is disposed. The tank 15 is provided with a fluid temperature sensor 41.

The fluid temperature sensor 41 detects a fluid temperature T [° C.] which is a temperature of the washer fluid in the tank 15, and outputs the detected fluid temperature to the control part 19. In FIG. 1, to facilitate understanding, the fluid temperature sensor 41 is configured to be provided to detect the fluid temperature T of the washer fluid in the tank 15, but is not limited to this. That is, the fluid temperature sensor 41 may be provided to detect the fluid temperature T, not in the tank 15, but between an outlet of the tank 15 and the nozzle 13 through the pipe 18. For example, a temperature detecting element of the fluid temperature sensor 41 may be inserted into the pipe 18 from a peripheral wall thereof in a state of not interfering with flow of the washer fluid, to detect the fluid temperature T.

The washer pump 16 is a drive source for injecting the washer fluid in the tank 15 from the nozzle 13 through the pipe 18. The washer pump 16 is an electric pump device in which a pump (not shown) for injecting the washer fluid, and a motor (not shown) for rotating an impeller (not shown) of the pump are integrated together, and is disposed on a lower surface of the tank 15.

The pipe 18 is a flow path which is formed of a vinyl polymer, a plastic material or the like, and connects the nozzle 13 and the pump 16, so that the washer fluid discharged from the pump 16 is supplied to the nozzle 13. The pipe 18 is connected to the nozzle 13 through a cavity (not shown) of the wiper arm 11, as a part thereof is shown in FIG. 2.

The control unit 19 shown in FIGS. 1 and 2 is for controlling operations of the wiper motor 14 and the washer pump 16, and is configured to include a motor control unit 21 and a pump control unit 23. Although not shown, the control unit 19 includes, for example, a CPU (Central Processing Unit), a ROM (Read Only Memory), a RAM (Random Access Memory), and a storage device such as a hard disk, and is configured such that these components are bus-connected so that information can be transmitted to each other.

As a general control, the motor control unit 21 rotates the wiper motor 14 by a motor control signal when a wiper switch 31 provided in an interior of the vehicle 1 is turned on, and stops the wiper motor 14 when the wiper switch 31 is turned off. Further, the motor control unit 21 reciprocates the wiper arm 11 by switching rotational direction of a rotary shaft of the motor 14 between normal rotation and reverse rotation according to the motor control signal, and in this case, increases or decreases a speed of reciprocation by increasing or decreasing current flowing through the motor 14. The wiper arm 11 moves forward in case of normal rotation of the motor 14, and moves backward in case of reverse rotation of the motor 14.

The reciprocating movement of the arm 11 is performed also when a washer switch 32 is turned on. That is, when the wiper switch 31 is in an OFF state, when the washer switch 32 is turned on, the pump 16 sucks the washer fluid from the tank 15 and discharges the washer fluid by control of a pump control signal outputted from the pump control unit 23. The discharged washer fluid is injected from the nozzle 13 through the pipe 18. Simultaneously with the injection, the arm 11 is reciprocally driven by the wiper motor 14, and the wiper blade 12 reciprocates for a predetermined number of times (for example, three times) on the outer surface of the glass 2. In this manner, the washer fluid is injected, for example, while the arm 11 reciprocates for three times. Further, when the wiper switch 31 is in an ON state, when the washer switch 32 is turned on, the washer fluid is injected for a predetermined time from the nozzle 13 which is reciprocating.

The motor control signal from the motor control part 21 is also outputted to an injection direction switching unit 13c provided inside the nozzle 13. When the inputted motor control signal is a normal rotation control signal, the injection direction switching unit 13c switches the flow path so that the washer fluid flowing through the pipe 18 in a direction shown by an arrow Y1 is injected from the forward side nozzle 13a as shown by an arrow Y1a. In contrast, when the inputted motor control signal is a reverse rotation control signal, the injection direction switching unit 13c switches the flow path so that the washer fluid is injected from the backward side nozzle 13b as shown by an arrow Y1b.

In this manner, by switching the injection direction of the washer fluid by the injection direction switching unit 13c, the washer fluid is injected from the forward side nozzle 13a as shown by the arrow Y1a when the arm 11 moves forward, and the washer fluid is injected from the backward side nozzle 13b as shown by the arrow Y1b when the arm 11 moves backward.

The pump control unit 23 includes a holding unit 23a made of a storage means such as a RAM or a flush memory capable of freely reading and writing data, and fluid temperature and discharge pressure correspondence table information D1 (also simply referred to as table information D1) stored in the storage means (not shown). The pump control unit 23 controls suction and discharge of the pump 16 and a discharge pressure in this case, so that the pump 16 discharges the washer fluid in the tank 15 to the pipe 18, by the pump control signal.

The pump control signal is, for example, a PWM (Pulse Width Modulation) control signal. It is possible to change a discharge pressure (pump discharge pressure P) of the pump 16 by variably controlling a rotational speed of the motor (not shown), which is a component of the pump 16, by changing a duty ratio of the PWM control signal. The duty ratio of the PWM control signal is increased when increasing the pump discharge pressure P, and the duty ratio is reduced when reducing the pump discharge pressure P.

Further, the pump control unit 23 applies the fluid temperature T of the washer fluid in the tank 15, which is currently detected by the fluid temperature sensor 41, to the fluid temperature and discharge pressure correspondence table information D1 to be described later, and determines the pump discharge pressure P corresponding to the detected fluid temperature T. Then, the pump control unit 23 controls the pump 16 to have the determined pump discharge pressure P. During this control, the currently detected fluid temperature T is held by overwriting as a previous fluid temperature Tq in the holding unit 23a.

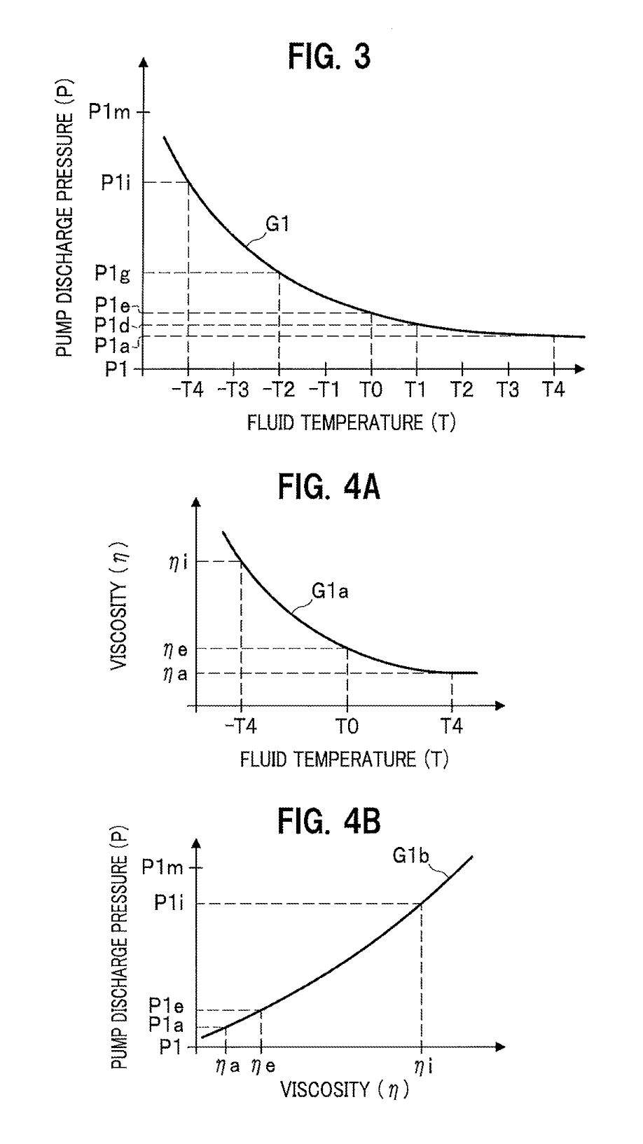

The table information D1 is a relationship between the fluid temperature T and the pump discharge pressure P shown in FIG. 3, which is represented by data values. FIG. 3 is a fluid temperature and discharge pressure correspondence map showing a correspondence relationship between the fluid temperature T and the pump discharge pressure P by a graph line G1, when the fluid temperature T is represented by the horizontal axis as −T4 (low temperature) to T4 (high temperature) and the pump discharge pressure P is represented by the vertical axis as P1 (minimum discharge pressure) to P1m (maximum discharge pressure). Each pump discharge pressure P1 to P1i associated with each fluid temperature −T4 to T4 by the graph line G1 is a discharge pressure which can discharge an injection amount of the washer fluid capable of properly wiping the windshield glass 2.

In other words, the graph line G1 shows a correlation in which the pump discharge pressure P is increased as the fluid temperature T is lowered. For example, there is a relationship in which the pump discharge pressure is P1e when the fluid temperature is T0, and the pump discharge pressure is P1g higher than P1e when the fluid temperature is −T2 lower than T0.

The correspondence relationship between the fluid temperature T and the pump discharge pressure P shown in FIG. 3 is derived from a fluid temperature and viscosity correspondence map shown in FIG. 4A and a viscosity and discharge pressure correspondence map shown in FIG. 4B.

The map shown in FIG. 4A is a graph showing a correspondence relationship between the fluid temperature T and the viscosity η by a graph line G1a, when the fluid temperature T is represented by the horizontal axis as −T4 (low temperature) to T4 (high temperature) and the viscosity η [Pa·s] of the washer fluid is represented by the vertical axis as ηa (low viscosity) to ηi (high viscosity). The viscosity η corresponding to the fluid temperature T detected by the fluid temperature sensor 41 is obtained from the correspondence relationship between the fluid temperature T and the viscosity η.

The map shown in FIG. 4B is a graph showing a correspondence relationship between the viscosity η and the pump discharge pressure P by a graph line G1b, when the viscosity η is represented by the horizontal axis as ηa (low viscosity) to ηi (high viscosity) and the pump discharge pressure P is represented by the vertical axis as P1 (minimum discharge pressure) to P1m (maximum discharge pressure). As described above, the pump discharge pressure P corresponding to the viscosity η is obtained by applying the viscosity η determined from FIG. 4A to the correspondence relationship between the viscosity η and the pump discharge pressure P in FIG. 4B.

In this manner, the pump discharge pressure P corresponding to the currently detected fluid temperature T is obtained from the correspondence relationship between the temperature T and the pump discharge pressure P of the map shown in FIG. 3, which is derived from the maps shown in FIGS. 4A and 4B.

### Operation of First Embodiment

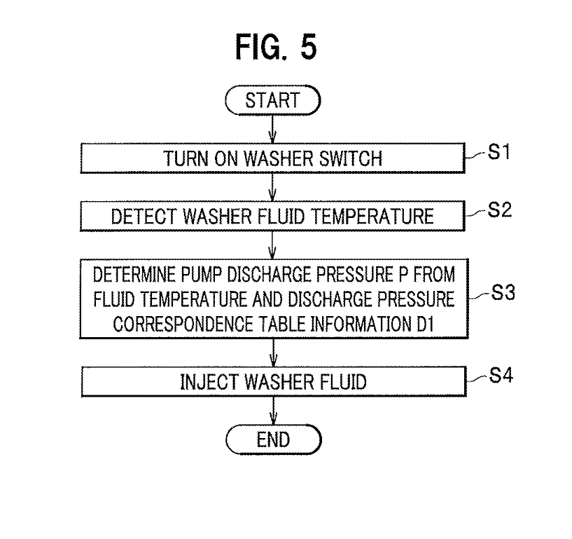

Next, control of the discharge pressure of the washer pump 16 by the control unit 19 will be described with reference to a flowchart shown in FIG. 5. Note that, it is assumed that an antifreeze washer fluid, which is not frozen even at a freezing temperature or lower, is stored as washer fluid in the washer tank 15.

In Step S1, when the wiper switch 31 is turned on, the motor control unit 21 reciprocates the wiper arm 11 by rotating the wiper motor 14 while alternately switching the normal rotation and reverse rotation by the motor control signal. In this case, the wiper blade 12 and the washer nozzle 13, which are attached to the arm 11, also reciprocate together with the arm 11. Further, it is assumed that the washer switch 32 is turned on, and the pump 16 is operated so that the washer fluid is injected from the nozzle 13.

Note that, it may be assumed that the washer switch 32 is turned on, and the washer fluid is injected from the nozzle 13, and at the same time, the arm 11 is reciprocally driven by the motor 14, and the blade 12 reciprocates on the outer surface of the glass 2 for a predetermined number of times, while the washer fluid is injected.

In Step S2, the fluid temperature T of the antifreeze washer fluid in the tank 15 is detected by the fluid temperature sensor 41, and is outputted to the pump control unit 23. The detected fluid temperature T is, for example, assumed to be “−T2” shown in FIG. 3.

In Step S3, the pump control unit 23 determines the pump discharge pressure P corresponding to a detected fluid temperature −T2 from the fluid temperature and discharge pressure correspondence table information D1. That is, a pump discharge pressure P1g corresponding to the fluid temperature −T2 shown in FIG. 3 is obtained. The pump discharge pressure P1g is higher than a pump discharge pressure P1e corresponding to a fluid temperature T0 currently held in the holding unit 23a. The pump control unit 23 controls the discharge pressure of the pump 16 to be the determined pump discharge pressure P1g. In this case, the fluid temperature −T2 is held by overwriting in the holding unit 23a.

In Step S4, the pump 16 discharges the antifreeze washer fluid from the tank 15 to the pipe 18 at the pump discharge pressure P1g determined in Step S3. As a result, a required amount of the antifreeze washer fluid for properly wiping the windshield glass 2 is injected from the nozzle 13 to the glass 2.

Meanwhile, for example, when the detected fluid temperature T is a fluid temperature T1 higher than the held fluid temperature T0, the pump control unit 23 determines a pump discharge pressure P1d corresponding to the fluid temperature T1 from the table information D1. The pump discharge pressure P1d is lower than the pump discharge pressure P1e corresponding to the fluid temperature T0. By the pump 16 of the pump discharge pressure P1d, the antifreeze washer fluid is discharged to the pipe 18, to be injected from the nozzle 13.

### Effects of First Embodiment

The above-described washer injector 10 of the first embodiment includes the washer nozzle 13 for injecting the washer fluid to the windshield glass 2 of the vehicle 1, the washer pump 16 for supplying the washer fluid to the washer nozzle 13, the fluid temperature sensor 41 as a detection unit for detecting the fluid temperature which is the temperature of the washer fluid, and the control unit 19 for controlling the discharge pressure of the washer pump 16. The control unit 19 controls the discharge pressure of the washer pump 16 to be higher when the fluid temperature T detected by the fluid temperature sensor 41 is low than when the fluid temperature T is high.

With this configuration, even when the temperature of the washer fluid is low and the viscosity thereof is increased, the discharge pressure of the washer pump 16 (pump discharge pressure P) is increased as the viscosity is increased, and thus it is possible to inject a required amount of washer fluid for properly wiping the windshield glass. In other words, it is possible to prevent wiping performance degradation.

Further, when the temperature of the washer fluid is high and the viscosity thereof is low, the pump discharge pressure P is controlled to be low. In a case of this control, the pump discharge pressure P is low and the discharge amount is reduced, however, the discharge amount is more than that at low temperature because the viscosity is low and the washer fluid easily flows. Therefore, even when the pump discharge pressure is reduced, it is possible to inject the required amount of washer fluid for properly wiping the glass, as well as to prevent unnecessary consumption of the washer fluid.

That is, even when the viscosity η is increased or decreased depending on temperature change of the washer fluid, it is possible to inject an amount of washer fluid capable of properly wiping the glass 2 so that the washer fluid is not excessively injected.

### Modification 1 of First Embodiment

Next, a modification 1 of the first embodiment will be described. The pump control unit 23 holds a predetermined threshold temperature Th in the hold portion 23a, and when the fluid temperature T detected by the fluid temperature sensor 41 is equal to or lower than the threshold temperature Th, the pump control unit 23 controls the pump discharge pressure P to be higher than a discharge pressure at a time when the fluid temperature T is higher than the threshold temperature Th.

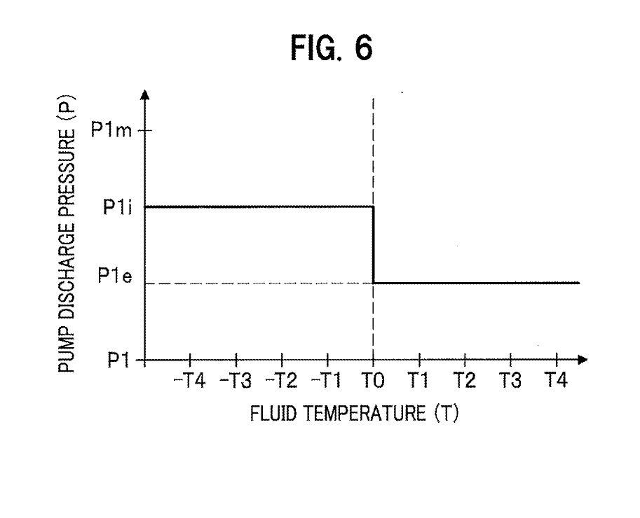

For example, the pump control unit 23 defines that the threshold temperature Th is T0 shown in FIG. 6, and holds the threshold temperature T0 in the holding unit 23a. It is assumed that the threshold temperature T0 is below zero, and is a temperature at which an amount of washer fluid capable of properly wiping the glass cannot be injected at a low pump discharge pressure P1e. As shown in FIG. 6, the pump control unit 23 controls the pump discharge pressure P to be P1e when the detected fluid temperature T is higher than T0. Then, the pump control unit 23 controls the pump discharge pressure P to be a pump discharge pressure P1i higher than P1e, when the detected fluid temperature T is equal to or lower than the threshold temperature T0. As a result, even when the temperature of the washer fluid is below zero and lowered to a temperature at which an amount of washer fluid capable of properly wiping the glass cannot be injected, it is possible to increase the injection amount of the washer fluid to be an amount capable of properly wiping the glass by a simple control.

### Modification 2 of First Embodiment

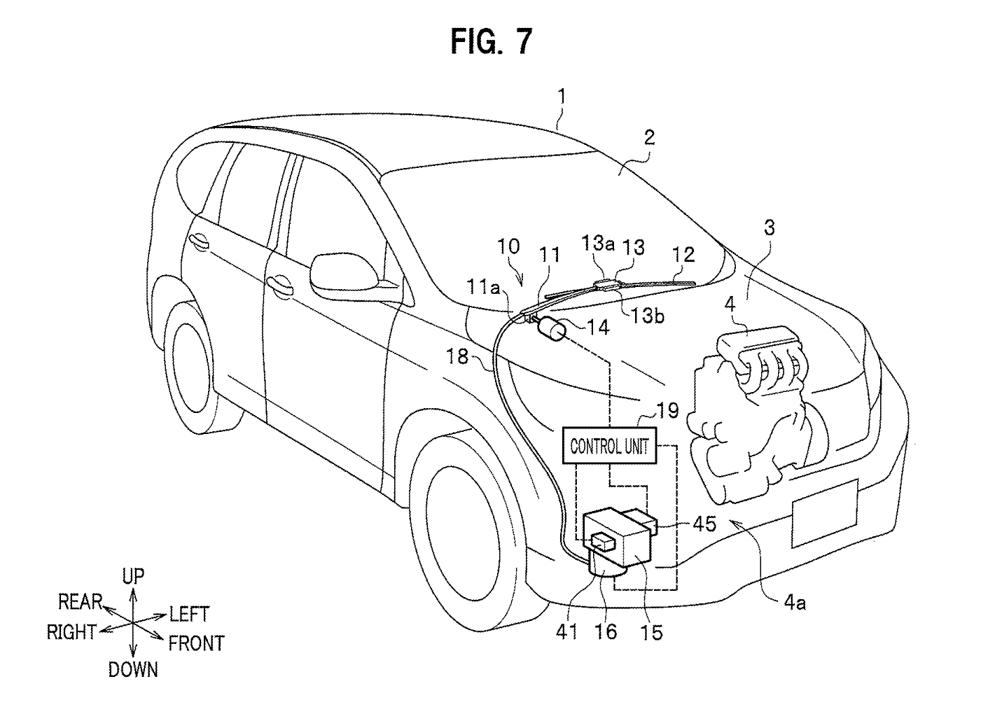

Next, modification 2 of the first embodiment will be described. As shown in FIG. 7, the washer tank 15 is further provided with a component sensor 45. The component sensor 45, in which a component detecting element (not shown) for detecting components of the washer fluid is inserted into the tank 15, is for detecting the components contained in the washer fluid by the component detecting element and outputting the detected components to the control unit 19.

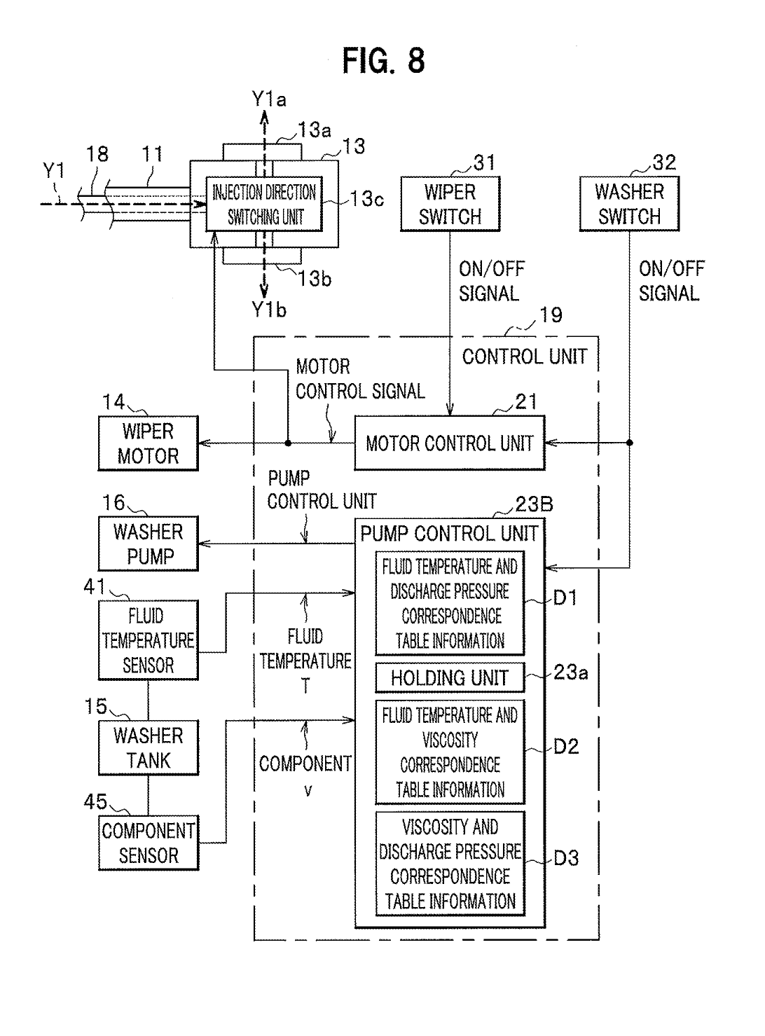

As shown in FIG. 8, a pump control unit 23B further includes a temperature and viscosity correspondence table information D2 and a viscosity and discharge pressure correspondence table information D3, which are stored in the storage means (not shown). Incidentally, the temperature and viscosity correspondence table information D2 is also referred to as table information D2, and the viscosity and discharge pressure correspondence table information D3 is also referred to as table information D3.

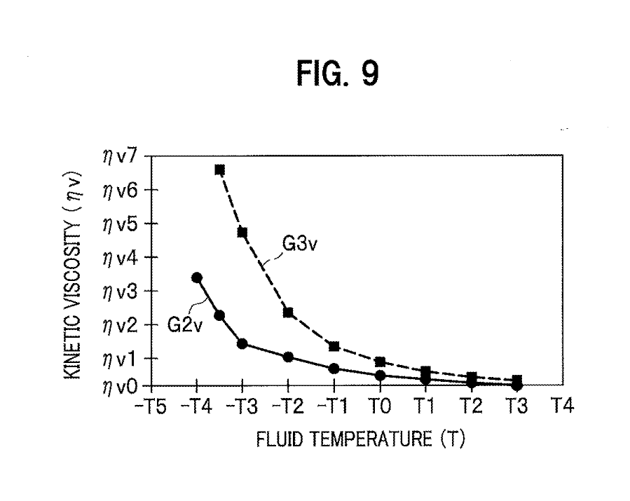

The table information D2 is a relationship between the fluid temperature T and a kinetic viscosity ηv shown in FIG. 9, which is represented by data values. FIG. 9 is a fluid temperature and viscosity correspondence map showing a relationship between the fluid temperature T and the kinetic viscosity ηv by two different graph lines G2v and G3v, when the fluid temperature T is represented by the horizontal axis as −T5 (low temperature) to T4 (high temperature) and the kinetic viscosity ηv [m²/s] of the washer fluid is represented by the vertical axis as ηv0 (low viscosity) to ηv7 (high viscosity). Note that, since the kinetic viscosity is commonly referred to as viscosity, it is assumed that the kinetic viscosity is included in the viscosity described in claims.

One graph line G2v shows a correspondence relationship between the fluid temperature T and the kinetic viscosity ηv of the washer fluid containing methanol system components. The other graph line G3v shows a correspondence relationship between the fluid temperature T and the kinetic viscosity ηv of the washer fluid containing ethanol system components.

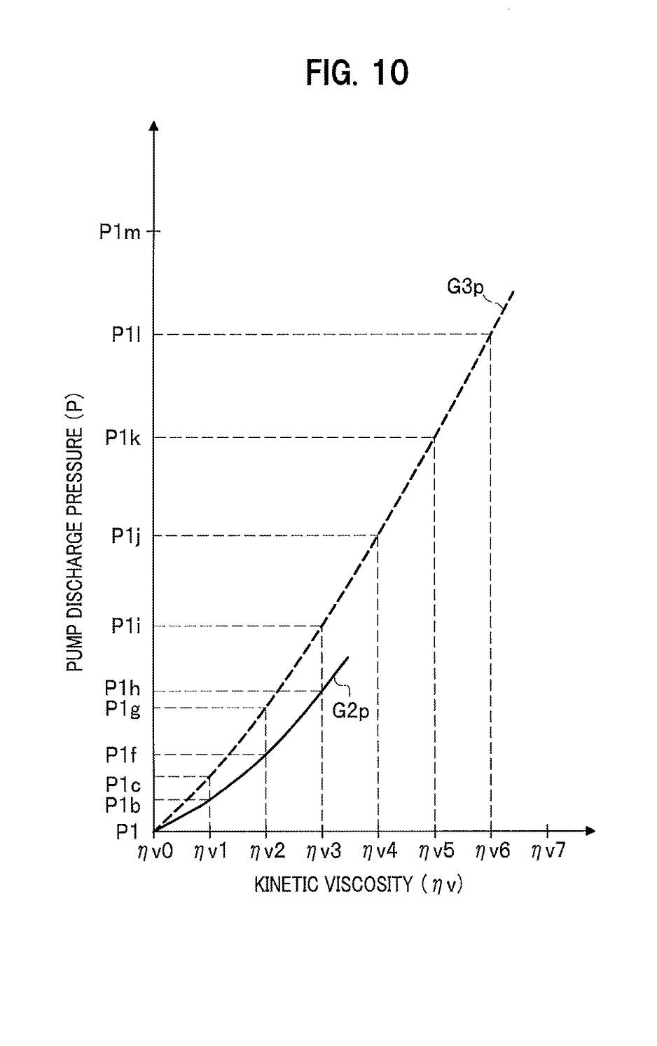

The table information D3 is a relationship between the kinetic viscosity ηv and the pump discharge pressure P shown in FIG. 10, which is represented by data values. FIG. 10 is a viscosity and discharge pressure correspondence map showing a correspondence relationship between the kinetic viscosity ηv and the pump discharge pressure P by two different graph lines G2p and G3p, when the kinetic viscosity ηv [m²/s] of the washer fluid is represented by the horizontal axis as ηv0 (low viscosity) to ηv7 (high viscosity) and the pump discharge pressure P is represented by the vertical axis as P1 (minimum discharge pressure) to P1m (maximum discharge pressure). The pump discharge pressure P of the map is the discharge pressure capable of discharging a required amount of washer fluid for properly wiping the glass 2 when the kinetic viscosity is ηv.

One graph line G2p corresponds to the graph line G2v (FIG. 9), and the other graph line G3p corresponds to the graph line G3v (FIG. 9). Note that, in the present embodiment, the pump control unit 23B holds the table information D2, D3 of two components of methanol system and ethanol system, which are shown by the graph lines G2v, G3v in FIG. 9 and the graph lines G2p, G3p in FIG. 10, however, the pump control unit 23B may hold the table information of three or more components.

At first, with reference to the table information D2, the pump control unit 23B determines the kinetic viscosity ηv of the washer fluid corresponding to the fluid temperature T detected by the fluid temperature sensor 41 from the correspondence relationship between the fluid temperature T and the kinetic viscosity ηv of the washer fluid containing a component v detected by the component sensor 45. For example, it is assumed that the washer fluid containing the detected component v contains an ethanol component, and has the correspondence relationship between the fluid temperature T and the kinetic viscosity ηv, which is shown by the graph line G3v shown in FIG. 9. In this case, it is assumed that the kinetic viscosity ηv of the washer fluid corresponding to the detected fluid temperature T is, for example, determined to be ηv2.

Next, the pump control unit 23B applies the kinetic viscosity ηv, which is determined above, to the correspondence information between the kinetic viscosity ηv and the pump discharge pressure P, which is shown by the graph line G3p (FIG. 10) corresponding to the graph line G3v (FIG. 9) of the table information D3, and determines the pump discharge pressure P1g corresponding to the kinetic viscosity ηv2. Then, the pump control unit 23B sets the discharge pressure of the pump 16 to the pump discharge pressure P1g. This makes it possible to inject the required amount of washer fluid for properly wiping the glass 2 from the nozzle 13.

### Configuration of Second Embodiment

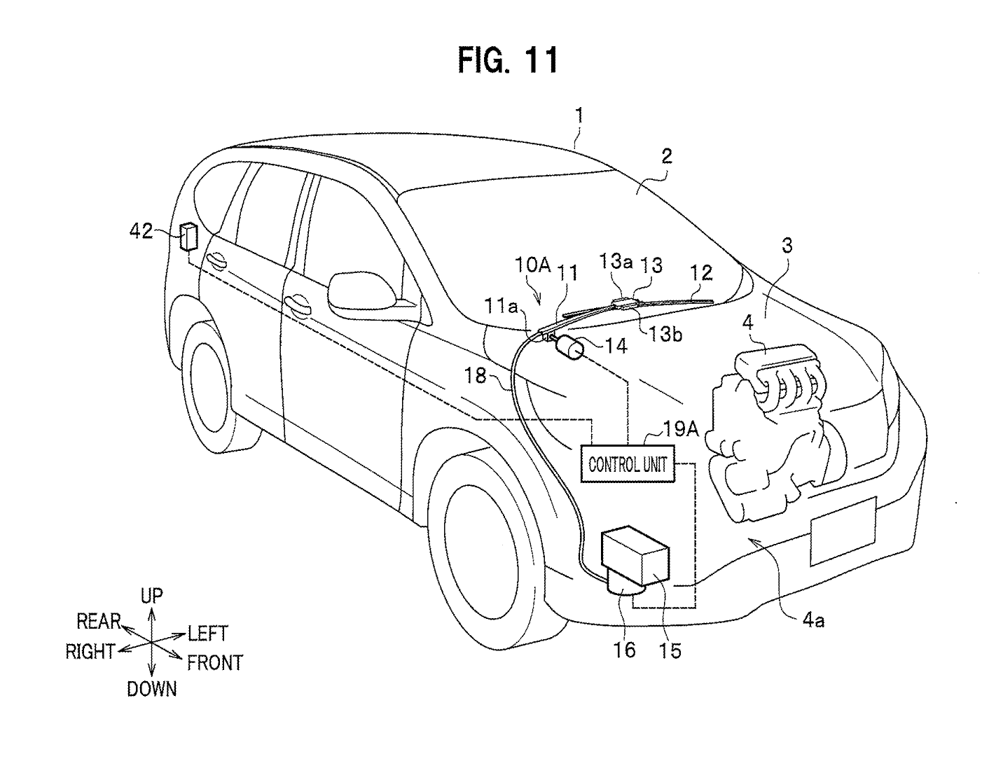

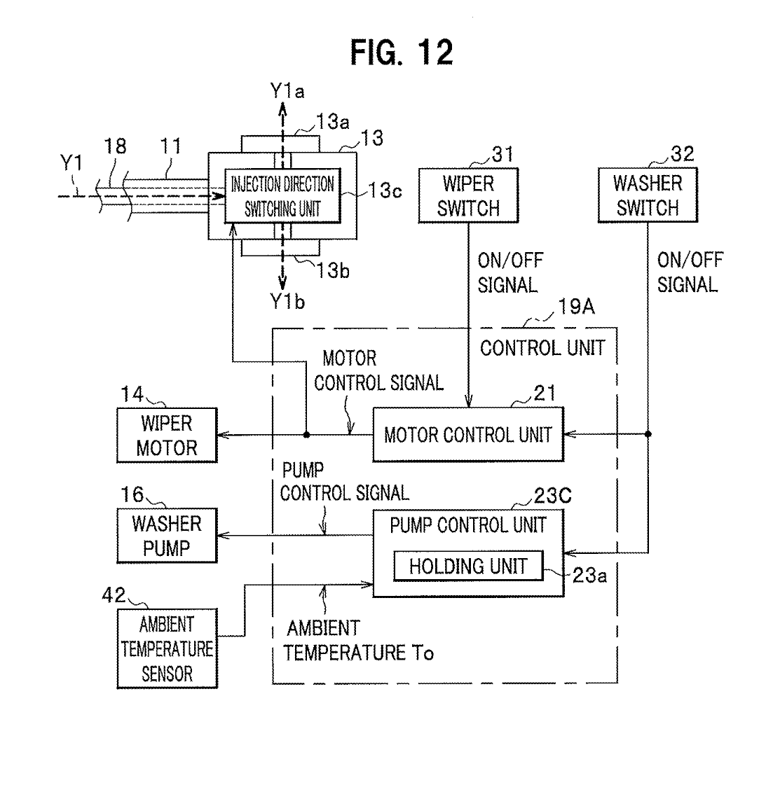

FIG. 11 is a perspective view of a vehicle equipped with a washer injector according to a second embodiment of the present invention. The washer injector 10A shown in FIG. 11 differs from the washer injector 10 shown in FIG. 1, in that the washer injector 10A does not include the fluid temperature sensor 41, but uses an ambient temperature sensor (obtaining unit) 42 mounted on the vehicle 1 in advance, and a control unit 19A includes a pump control unit 23C having the holding unit 23a as shown FIG. 12.

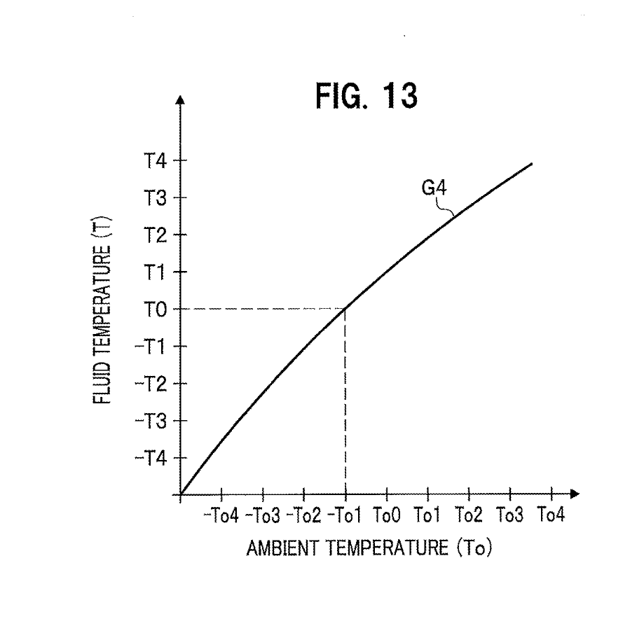

The ambient temperature sensor 42 is an ambient temperature sensor used for air conditioner control and the like, and detects (obtains) an ambient temperature To, to output it to the pump control unit 23C. Here, a relationship between the ambient temperature To and the fluid temperature T of the washer fluid is such that, as shown in FIG. 13, as the ambient temperature To on the horizontal axis is increased toward To4 from −To4, the fluid temperature T on the vertical axis is also increased toward T4 from −T4. One example of this relationship is shown by a graph line G4. Note that, as described in the first embodiment, it is assumed that the fluid temperature T is a temperature in the tank 15 or between the outlet of the tank 15 and the nozzle 13 through the pipe 18.

Further, the relationship between the fluid temperature T and the viscosity η of the washer fluid is as has been described with reference to FIG. 4A. Furthermore, the relationship between the viscosity η and the pump discharge pressure P is as has been described with reference to FIG. 4B.

The pump control unit 23C holds a specific ambient temperature Tos in the holding unit 23a. The specific ambient temperature Tos is a temperature of when it is not possible to inject the required amount of washer fluid for properly wiping the glass 2 by an increase of the viscosity η associated with a reduction of the fluid temperature T of the washer fluid due to a reduction of the ambient temperature To. For example, as shown in FIG. 13, when the detected ambient temperature To is reduced to −To1, the fluid temperature T is T0, and then the viscosity η is ηe as shown in FIG. 4A. When the viscosity η is ηe, the pump discharge pressure P is P1e as shown in FIG. 4B. The ambient temperature −To1 at this time is held in the holding unit 23a as the specific ambient temperature Tos, which is equal to −To1, in advance.

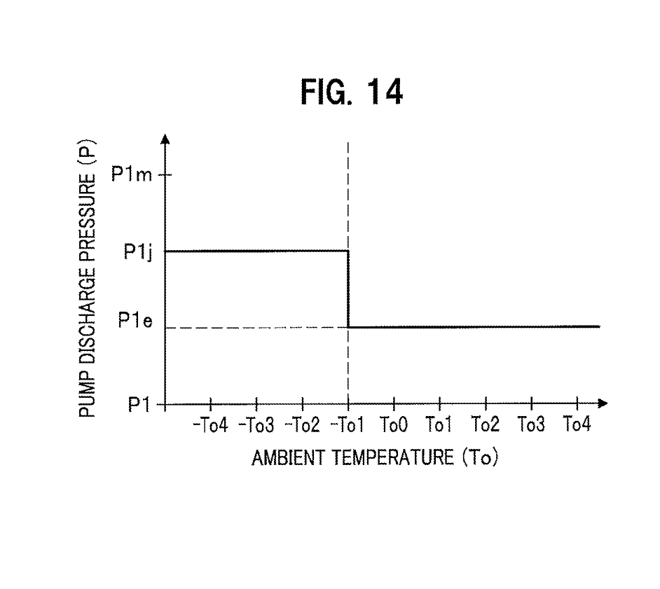

When the ambient temperature To detected by the ambient temperature sensor 42 is equal to or lower than the specific ambient temperature Tos held in the holding unit 23a, the pump control unit 23C controls the pump discharge pressure P to a pressure higher than discharge pressure at a high temperature at which the ambient temperature To exceeds the specific ambient temperature Tos. For example, as shown in FIG. 14 showing a relationship between the ambient temperature To and the pump discharge pressure P, when the detected ambient temperature To is equal to or lower than a specific ambient temperature −To1, the pump control unit 23C controls the pump discharge pressure P to a pressure “P1j” higher than the pump discharge pressure P1e at a time when the ambient temperature To is the specific ambient temperature −To1.

### Effects of Second Embodiment

By this control, the pump discharge pressure P is “P1j”, which is higher than a pump discharge pressure P2j at a time when the glass 2 cannot be properly wiped, and thus it is possible to inject an amount of the washer fluid which can properly wipe the glass 2. Further, as the ambient temperature sensor 42, an ambient temperature sensor used for controlling an air conditioner or the like, which is mounted on the vehicle 1 in advance, only have to be used, and thus it is not necessary to newly provide the ambient temperature sensor 42, and it is possible to reduce the cost accordingly.

### Modification 1 of Second Embodiment

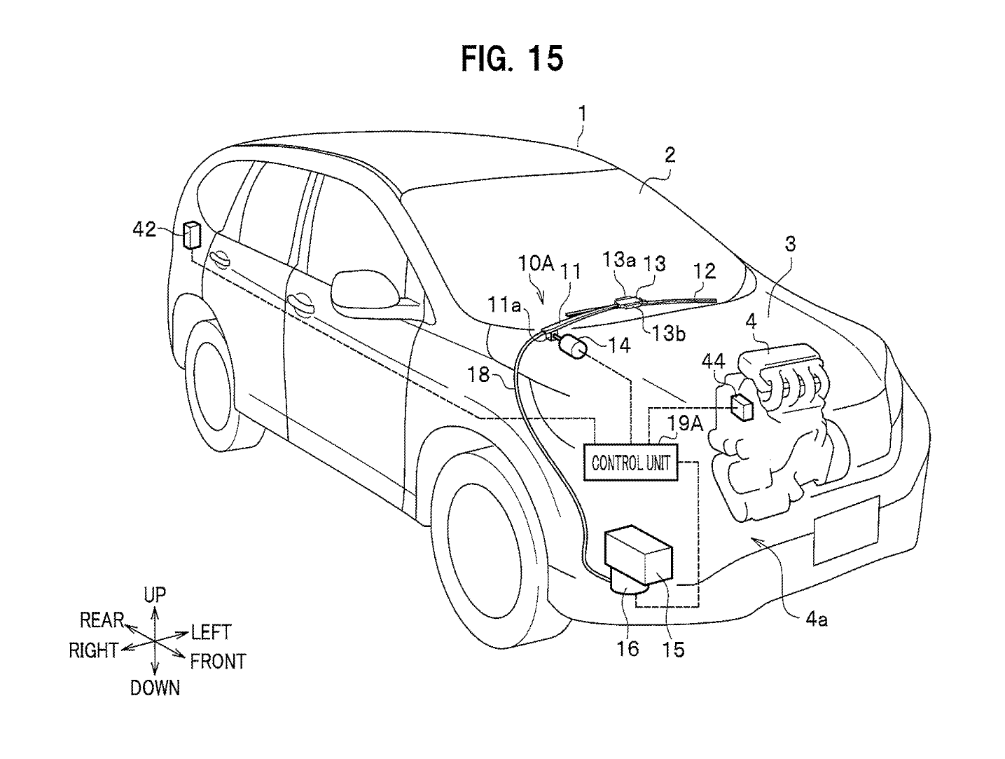

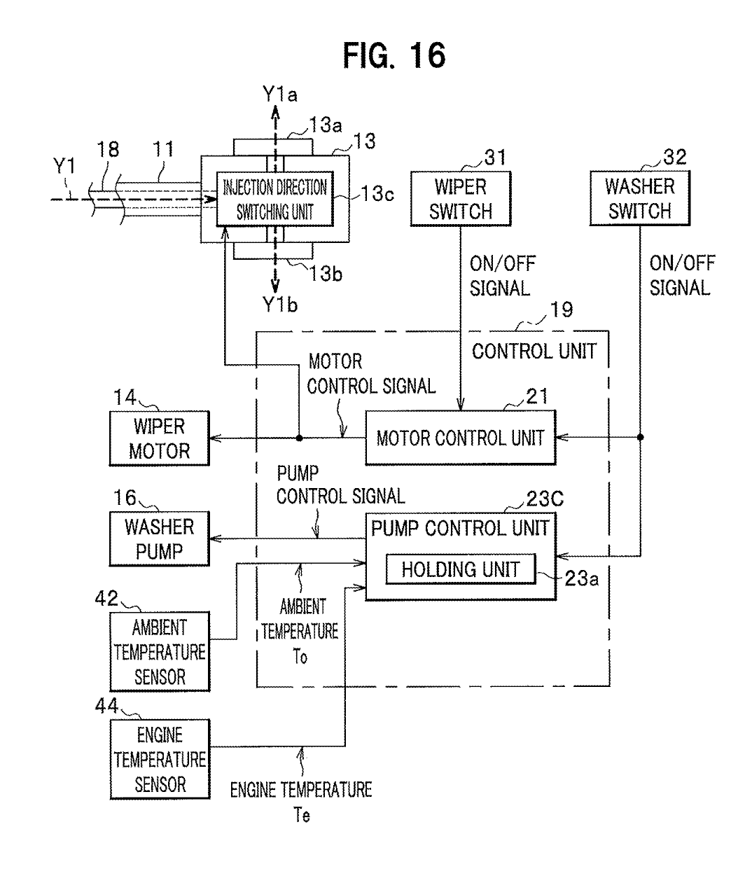

Next, a modification 1 of the second embodiment will be described. The washer injector 10A shown in FIG. 15 differs from the washer injector 10A shown in FIG. 11, in that the washer injector 10A in FIG. 15 further includes an engine temperature sensor (obtaining unit) 44, and the pump control unit 23C of the control unit 19A controls the pump discharge pressure P further by using an engine temperature Te detected (obtained) by the engine temperature sensor 44 as shown in FIG. 16.

The engine temperature sensor 44 detects the engine temperature Te of the engine 4 in an engine compartment 4a in which the tank 15 is disposed, and outputs the engine temperature Te to the pump control unit 23C.

Here, a relationship between the engine temperature Te and the fluid temperature T of the washer fluid is such that the fluid temperature T is increased as the engine temperature Te is increased, as in the relationship between the ambient temperature To and the fluid temperature T in FIG. 13. That is, the fluid temperature T is increased when the engine temperature Te is increased, even when the ambient temperature To is low.

Further, the relationship between the fluid temperature T and the viscosity η of the washer fluid is such that, as shown in FIG. 4A, the viscosity η is reduced as the fluid temperature T is increased, and thus, when the engine temperature Te is high, the washer fluid easily flows through the flow path, because the washer fluid in the tank 15 in the engine compartment 4a is warmed and the viscosity is low.

The pump control unit 23C holds in advance in the holding unit 23a a specific engine temperature Tes of when the washer fluid in the tank 15 has a viscosity which allows the required amount of washer fluid for properly wiping the glass 2 to be injected.

Further, as described in the second embodiment, the pump control unit 23C performs the following control, even when the ambient temperature To detected by the ambient temperature sensor 42 is equal to or lower than the specific ambient temperature −To1 (see FIG. 14). That is, when the engine temperature Te detected by the engine temperature sensor 44 is equal to or higher than the specific engine temperature Tes, the pump control unit 23C controls the pump discharge pressure P to be lower than that when the engine temperature Te is lower than the specific engine temperature Tes.

For example, in the second embodiment, as shown in FIG. 14, when the detected ambient temperature To is equal to or lower than the specific ambient temperature −To1, the pump control unit 23C controls the pump discharge pressure P to “P1j” higher than the discharge pressure P1e at a time when the ambient temperature To is the specific ambient temperature −To1.

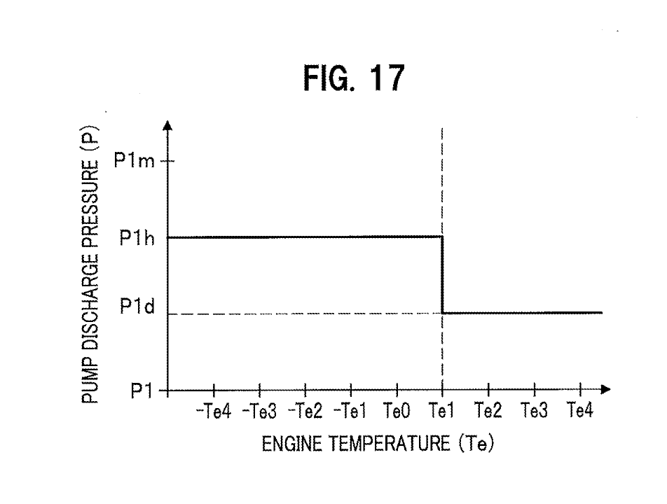

However, in this modification 1, even when the detected ambient temperature To is equal to or lower than the specific ambient temperature −To1, as shown in FIG. 17, when the detected engine temperature Te is equal to or higher than the specific engine temperature Tel held in advance in the holding unit 23a, the pump control unit 23C controls the pump discharge pressure P to “P1d” lower than a discharge pressure P1h at a time when the engine temperature Te is lower than the specific engine temperature Tel. That is, when the engine temperature Te is equal to or higher than the specific engine temperature Tel, the washer fluid is warmed, the viscosity η is low, and the washer fluid easily flows, and thus the pump control unit 23C controls the pump discharge pressure P to be lowered to “P1d”.

The following effects can be obtained by this control. That is, even when the ambient temperature of the vehicle 1 is low, when the engine temperature Te is high, the washer fluid in the tank 15 in the engine compartment 4a is warmed, the viscosity η is low, and the washer fluid easily flows through the flow path. Therefore, by lowering the pump discharge pressure P, the injection amount is reduced without impairing the proper wiping of the glass 2, and thus it is possible to prevent unnecessary consumption of the washer fluid.

Further, as the engine temperature sensor 44, the engine temperature sensor, or a sensor for detecting engine coolant temperature, engine oil temperature, transmission oil temperature or the like, which is mounted on the vehicle in advance, only have to be used, and thus it is not necessary to newly provide the engine temperature sensor 44, and it is possible to reduce the cost accordingly.

In this modification 1, even when the ambient temperature of the vehicle 1 is low, when the engine temperature Te is high, the pump discharge pressure P is lowered, however, control such as reducing the pump discharge pressure P according to the detected engine temperature Te may be performed by detecting only the engine temperature Te without detecting the ambient temperature.

### Modification 2 of Second Embodiment

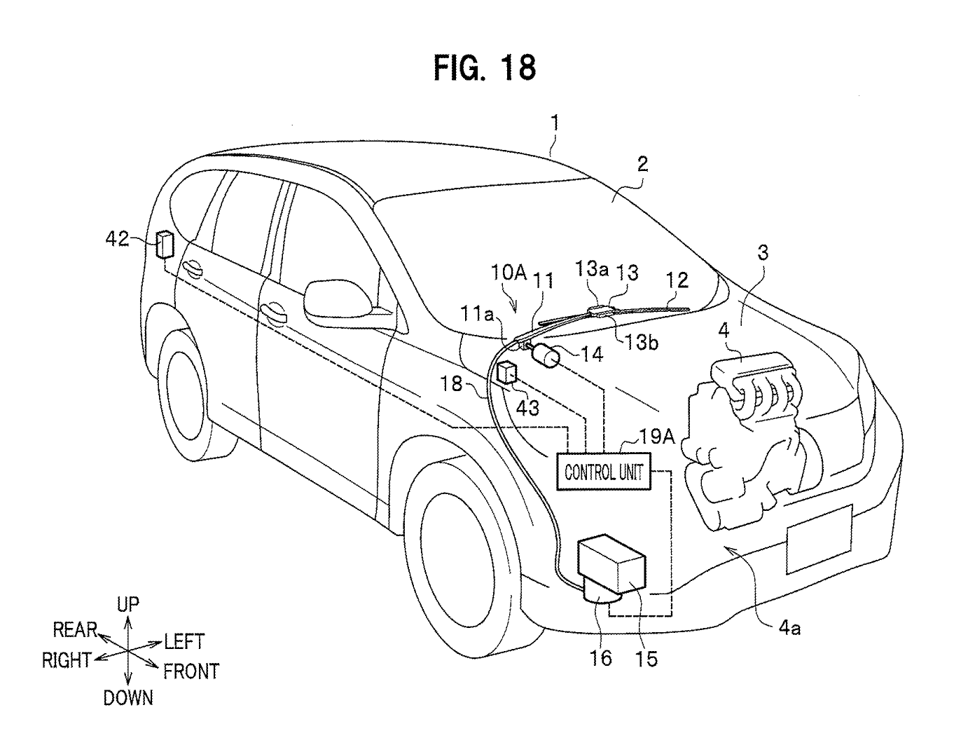

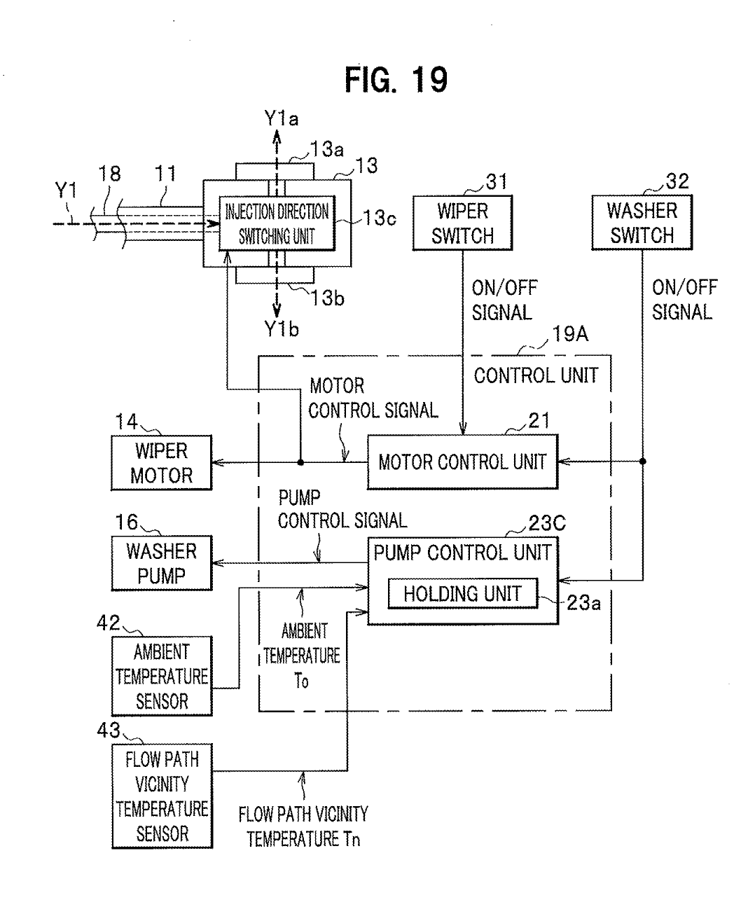

Next, a modification 2 of the second embodiment will be described. The washer injector 10A shown in FIG. 18 differs from the washer injector 10A shown in FIG. 11 in that the washer injector 10A in FIG. 18 further includes a flow path vicinity temperature sensor (obtaining unit) 43, and as shown in FIG. 19, the pump control unit 23C of the control unit 19A further uses a flow path vicinity temperature Tn detected by the flow path vicinity temperature sensor 43, to control the pump discharge pressure P. Note that, the flow path vicinity temperature Tn is a temperature in a vicinity of a flow path described in claims.

The flow path vicinity temperature sensor 43 detects (obtains) the temperature (flow path vicinity temperature) Tn in the vicinity of the flow path from the tank 15 to the nozzle 13, and outputs the detected temperature Tn to the pump control unit 23C.

Here, a relationship between the flow path vicinity temperature Tn and the fluid temperature T of the washer fluid is such that the fluid temperature T is increased as the flow path vicinity temperature Tn is increased, as in the relationship between the ambient temperature To and the fluid temperature T in FIG. 13.

Further, since the fluid temperature T and the viscosity η have the relationship shown in FIG. 4A, when the flow path vicinity temperature Tn is high, the washer fluid in the flow path is warmed, the viscosity η is low, and the washer fluid easily flows in the flow path.

The pump control unit 23C holds a specific flow path vicinity temperature Tns at a time when the washer fluid in the tank 15 has the viscosity which allows the required amount of washer fluid for properly wiping the glass 2 to be injected. Note that, the specific flow path vicinity temperature Tns is a specific preset temperature in the vicinity of the flow path described in claims.

As described in the second embodiment, the pump control unit 23C performs the following control, even when the ambient temperature To detected by the ambient temperature sensor 42 is equal to or lower than the specific ambient temperature −To1. That is, when the flow path vicinity temperature Tn detected by the flow path vicinity temperature sensor 43 is equal to or higher than the specific flow path vicinity temperature Tns, the pump control unit 23C controls the pump discharge pressure P to be lower than a discharge pressure at a time when the flow path vicinity temperature Tn is lower than the specific flow path vicinity temperature Tns.

For example, in the second embodiment, as shown in FIG. 14, when the detected ambient temperature To is equal to or lower than the specific ambient temperature −To1, the pump control unit 23C controls the pump discharge pressure P to “P1j” higher than the discharge pressure P1e at a time when the ambient temperature To is the specific ambient temperature −To1.

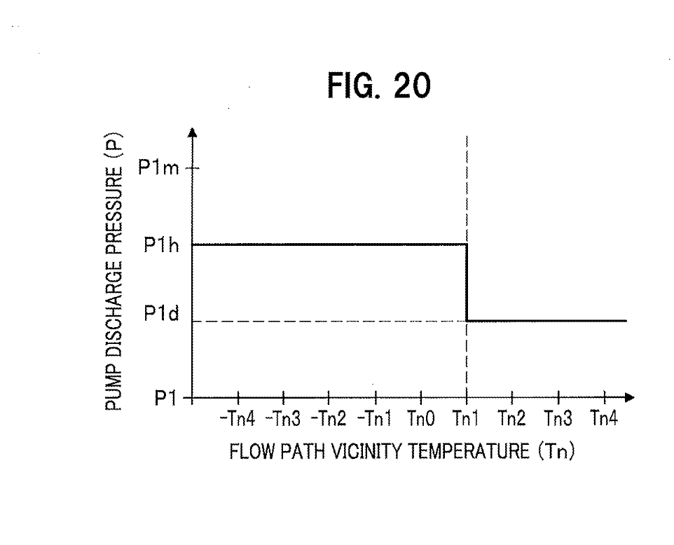

However, in this modification 2, even when the detected ambient temperature To is equal to or lower than the specific ambient temperature −To1, as shown in FIG. 20, when the detected flow path vicinity temperature Tn is equal to or higher than a specific flow path vicinity temperature Tn1 held in advance in the holding unit 23a, the pump control unit 23C controls the pump discharge pressure P to “P1d” lower than the discharge pressure P1h at a time when the flow path vicinity temperature Tn is lower than the specific flow path vicinity temperature Tn1. That is, when the flow path vicinity temperature Tn is equal to or higher than the specific flow path vicinity temperature Tns, the washer fluid is warmed, the viscosity η is low, and the washer fluid easily flows, and thus the pump control unit 23C controls the pump discharge pressure P to be lowered to “P1d”.

The following effects can be obtained by this control. That is, even when the ambient temperature of the vehicle 1 is low, when the flow path vicinity temperature Tn is high, the washer fluid is warmed, the viscosity η is low, and the washer fluid easily flows. Therefore, by lowering the pump discharge pressure P, the injection amount is reduced without impairing the proper wiping of the glass 2, and thus it possible to prevent unnecessary consumption of the washer fluid.

In this modification 2, even when the ambient temperature of the vehicle 1 is low, when the flow path vicinity temperature Tn is high, the pump discharge pressure P is lowered, however, control such as reducing the pump discharge pressure P according to the detected flow path vicinity temperature Tn may be performed by detecting only the flow path vicinity temperature Tn without detecting the ambient temperature.

### Modification 3

In addition, as described in the modification 1 of the first embodiment, in configurations in the second embodiment and the modifications 1, 2 thereof, the component sensor 45 (see FIG. 7) may be further provided in the washer tank 15. In this case, as the pump control unit 23B (see FIG. 8), the pump control unit 23C corrects the discharge pressure of the pump 16 to a pump discharge pressure (for example, “P1g” shown in FIG. 10) capable of discharging the required amount of washer fluid for properly wiping the glass 2. By this correction, it is possible to inject the required amount of washer fluid for properly wiping the glass 2 from the nozzle 13.

### Configuration of Third Embodiment

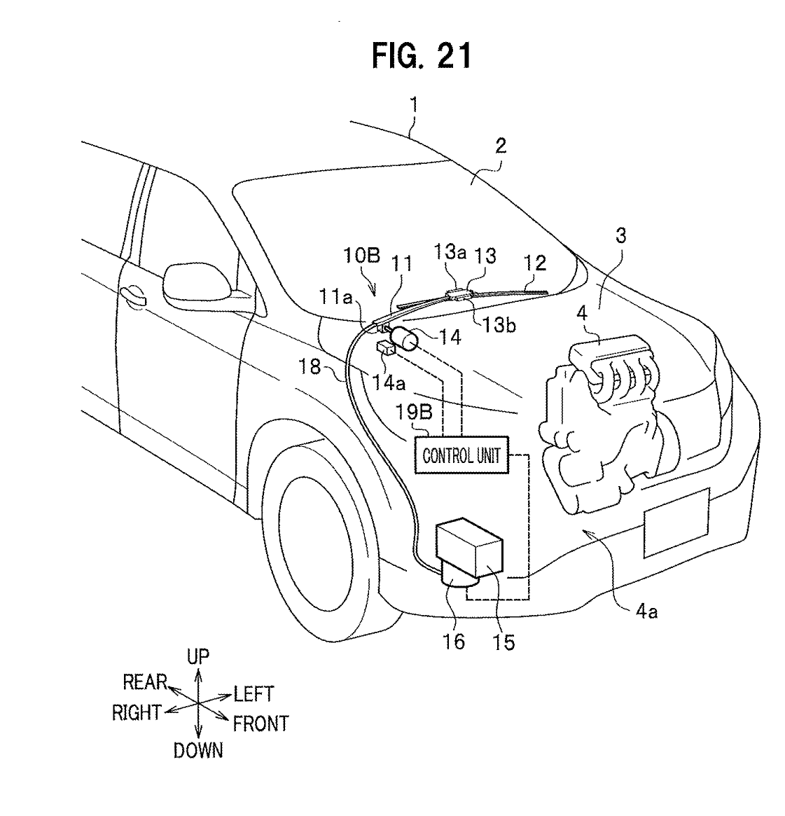

FIG. 21 is a perspective view of a vehicle equipped with a washer injector according to a third embodiment of the present invention. As shown in FIG. 21, a washer injector 10B of the vehicle 1 includes the wiper arm 11, the wiper blade 12, the washer nozzle 13, the wiper motor 14, the washer tank 15, the washer pump 16, and the pipe 18 for connecting the washer nozzle 13 and the washer pump 16, which are the same components as in FIG. 1. Further, the washer injector 10B is configured to include a rotation angle sensor 14a, and a control unit (control means) 19B, which are characteristic components of the third embodiment.

The rotation angle sensor 14a detects a rotation angle of a rotary shaft of the motor 14 and outputs it to the control unit (control means) 19B.

The wiper motor 14 is as described above, but it is also possible to use a motor such as a servo motor capable of changing the rotation angle. Note that, a drive mechanism described in claims is composed of the wiper motor 14 alone or a combination of the wiper motor 14, the gear link mechanism, the link rod and the like.

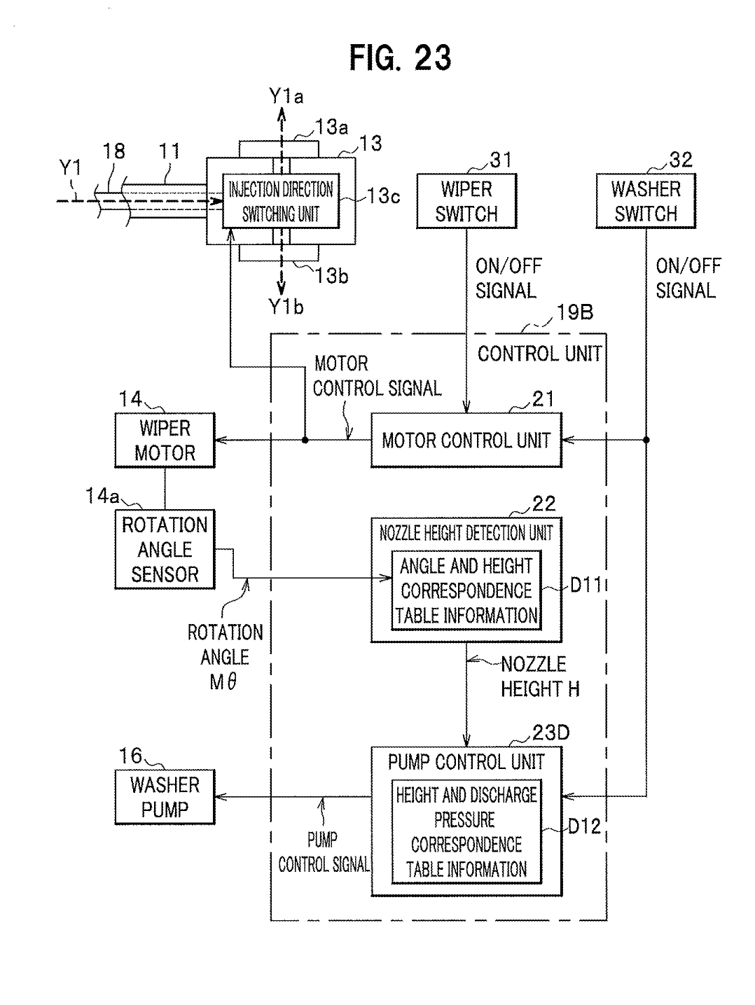

The washer nozzle 13 has the forward side nozzle 13a and the backward side nozzle 13b, and the switching of injection directions between the nozzle 13a and the nozzle 13b is performed by the control unit 19B (see FIG. 23) as described below.

The control unit 19B is for controlling operations of the wiper motor 14 and the washer pump 16, and is configured as shown in FIG. 23. As shown in FIG. 23, the control unit 19B is configured to include the motor control unit 21, a nozzle height detection unit 22 for storing angle and height correspondence table information D11 in a storage unit (not shown), and a pump control unit 23D for storing height and discharge pressure correspondence table information D12 in a storage unit (not shown). Note that, although not shown, the control unit 19B includes, for example, the CPU (Central Processing Unit), the ROM (Read Only Memory), the RAM (Random Access Memory), and the storage unit such as the hard disk, and is configured such that these elements are bus-connected so that they can transmit information to each other. Incidentally, the angle and height correspondence table information D11 and the height and discharge pressure correspondence table information D12 are also referred to as table information D11 and D12, respectively.

In the same manner as described above with reference to FIG. 2, the motor control unit 21 controls driving or stopping of the rotation of the wiper motor 14 by the motor control signal when the wiper switch 31 is turned on or turned off. Further, the motor control unit 21 controls the reciprocating movement of the wiper arm 11 by the motor control signal. Furthermore, the motor control unit 21 controls flow path switching of the injection direction switching unit 13c by the motor control signal.

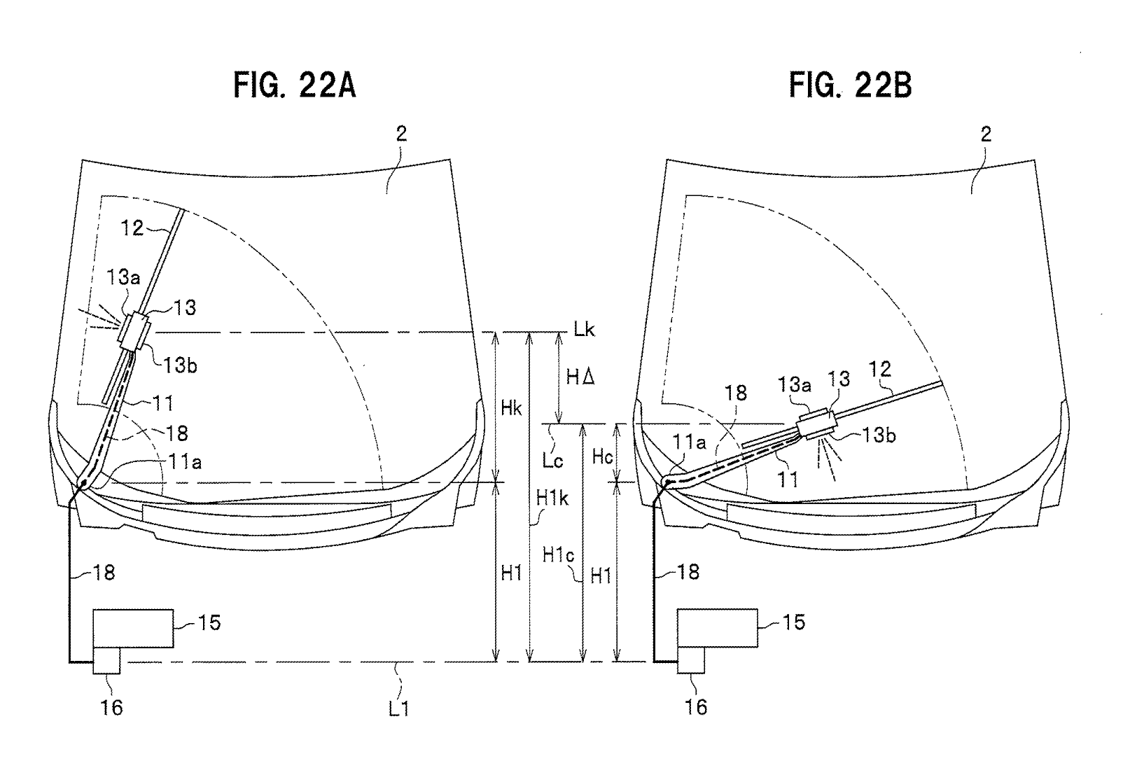

The nozzle height detection unit 22 shown in FIG. 23 is for detecting a nozzle height H. As shown in FIG. 22A or FIG. 22B, the nozzle height H is a height H1c between a position L1 of a discharge port of the washer fluid of the washer pump 16 and a position Lc of an injection port of the washer nozzle 13, or a height H1k between the position L1 and a position Lk of the injection port of the washer nozzle 13. The nozzle height H1c or H1k always varies during the reciprocating movement of the arm 11. Incidentally, FIGS. 22A and 22B shows a state where there is a water head difference HA between the nozzle height H1c and the nozzle height H1k, as an example.

The nozzle height H1c or H1k can be divided into a constant height (referred to as a base height) H1 between the position L1 of the discharge port of the washer pump 16 and the shaft of the arm rear end portion 11a, and a varying height (referred to as a variation height) Hc or Hk between the shaft of the arm rear end portion 11a and the position Lc or Lk of the injection port of the washer nozzle 13.

In more detail, the varying nozzle height H is as follows. For example, as shown in FIG. 22A, during forward movement of the arm 11, when the position of the injection port of the nozzle 13 is Lk, a variation height from the shaft of the arm rear end portion 11a to the position Lk of the injection port of the nozzle 13 is Hk. In this case, an added value of the variation height Hk and the base height H1 is the nozzle height H1k. As shown in FIG. 22B, during backward movement of the arm 11, when the position of the injection port of the nozzle 13 is Lc, a variation height from the shaft of the arm rear end portion 11a to the position Lc of the injection port of the nozzle 13 is Hc. In this case, a sum of the variation height Hc and the base height H1 is the nozzle height H1c.

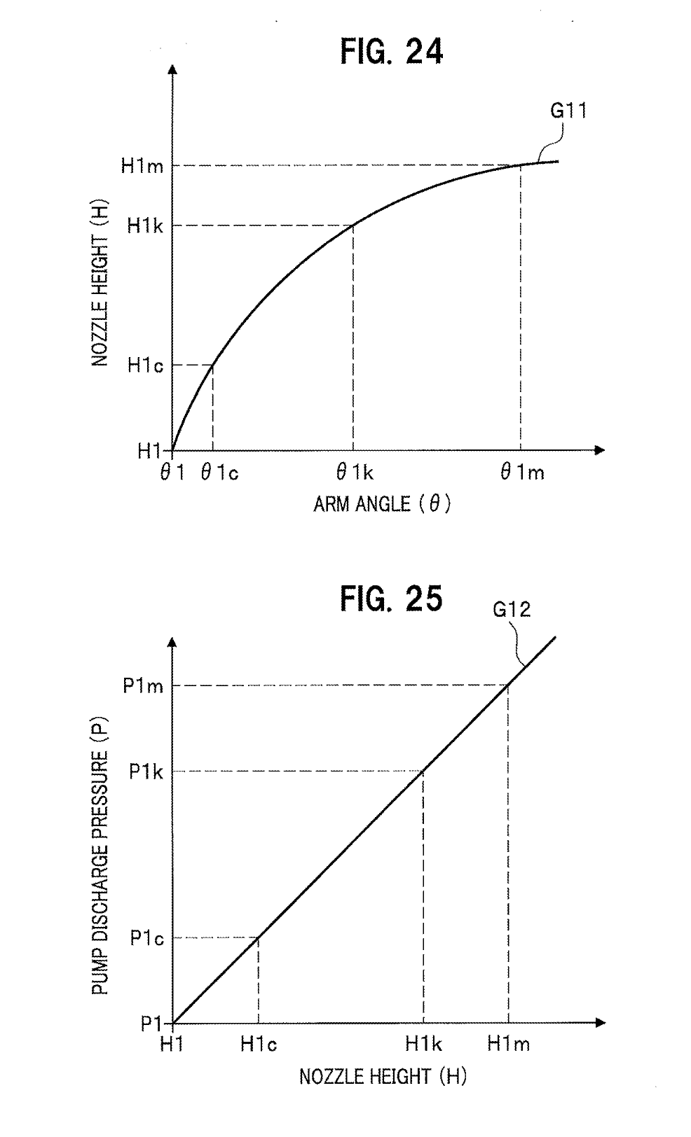

Here, since a length of the arm 11 is constant, when an operating angle (referred to as an arm angle θ) of the arm 11 is known, the variation heights Hc and Hk from the shaft of the arm rear end portion 11a to the injection port of the nozzle 13, which are shown in FIGS. 22A and 22B, can be determined by triangulation. By adding the variation height Hc or Hk to the base height H1, the nozzle height H1c or H1k can be determined. Therefore, a relationship between the arm angle θ and the nozzle height H is determined by measuring in advance, as an angle and height correspondence map (referred to as a map) shown in FIG. 24.

FIG. 24 is the angle and height correspondence map showing the relationship between the arm angle θ and the nozzle height H by a graph line G11, when the arm angle is represented by the horizontal axis as θ1 (minimum angle) to θ1m (maximum angle) and the nozzle height is represented by the vertical axis as H1 (minimum height) to H1m (maximum height). The correspondence relationship between the arm angle θ and the nozzle height H in this map is represented by data values in the angle and height correspondence table information D11 shown in FIG. 23.

When the nozzle height detection unit 22 detects the nozzle height H, the nozzle height detection unit 22 converts a rotation angle Mθ, which is detected by the rotation angle sensor 14a, of the rotary shaft of the wiper motor 14 to the arm angle θ, and applies the converted arm angle θ to the table information D11, to detect the nozzle height H.

However, here, in order to simplify the description, it will be described assuming that the rotation angle Mθ of the wiper motor 14 and the arm angle θ are the same. For example, when the operating angle (arm angle θ) of the linear arm 11 is 0° (minimum angle) to 90° (maximum angle) with respect to a horizontal line, the rotation angle Mθ of the motor 14 is also 0° to 90°, and the arm 11 is adapted to reciprocate since the motor 14 is rotated in the forward and reverse directions alternately between this 0° and 90°.

The nozzle height H detected by the nozzle height detection unit 22 as described above is inputted to the pump control unit 23D. The pump control unit 23D controls the washer pump 16 by the pump control signal such that the pump 16 discharges the washer fluid in the tank 15 to the pipe 18 (FIG. 21) at the pump discharge pressure P corresponding to the inputted nozzle height H.

The pump control signal is, for example, a PWM control signal. It is possible to change the pump discharge pressure P of the pump 16 by variably controlling the rotational speed of the motor (not shown), which is the component of the pump 16, by changing the duty ratio of the PWM control signal. The duty ratio of the PWM control signal is increased when increasing the pump discharge pressure P, and the duty ratio is reduced when reducing the pump discharge pressure P.

A relationship between the nozzle height H and the pump discharge pressure P is determined as a height and discharge pressure correspondence map (also referred to as a map) shown in FIG. 25. FIG. 25 shows the nozzle height H as H1 (minimum height) to H1m (maximum height) in the horizontal axis, and shows the pump discharge pressure P as P1 (minimum discharge pressure) to P1m (maximum discharge pressure) in the vertical axis. Further, the relationship between the nozzle height H and the pump discharge pressure P is shown by a graph line G12. The pump discharge pressure P is defined such that an injection amount of the washer fluid injected from the nozzle 13 is constant (for example, constant injection amount of 1.5 cc/sec) regardless of the nozzle height H. The constant injection amount of the washer fluid can be changed arbitrarily. The correspondence relationship between the nozzle height H and the pump discharge pressure P in the map in FIG. 25 is represented by data values in the height and discharge pressure correspondence table information D12.

In more detail, the relationship between the nozzle height H and the pump discharge pressure P, which is shown by the graph line G12, shows a relationship in which the pump discharge pressure P is increased or decreased in accordance with the nozzle height H so that the injection amount of the washer fluid injected from the washer nozzle 13 is constant regardless of the nozzle height H. In other words, based on the graph line 12, the pump control unit 23D shown in FIG. 23 controls the pump discharge pressure P to be higher when the nozzle height H is high than when the nozzle height H is low so that the injection amount of the washer fluid from the washer nozzle 13 is constant. By this control, the injection amount of the washer fluid injected from the washer nozzle 13 is constant regardless of a height position of the nozzle 13.

Therefore, the pump control unit 23D applies the nozzle height H detected by the nozzle height detection unit 22 to the table information D12, to determine the pump discharge pressure P. Then, the pump control unit 23D controls the discharge pressure of the pump 16 to be the determined pump discharge pressure P by the pump control signal. By this control, the pump 16 sucks the washer fluid from the tank 15 and discharges it to the pipe 18 (FIG. 21) at the controlled discharge pressure P. The washer fluid discharged to the pipe 18 is injected from the nozzle 13 to the glass 2 through the pipe 18 at the constant injection amount of, for example, 1.5 cc/sec.

Note that, the angle and height correspondence table information D11 and the height and discharge pressure correspondence table information D12 may be combined into one. This is angle and discharge pressure correspondence table information corresponding to a map in which the arm angle θ shown in FIG. 24 is represented by the horizontal axis, and the pump discharge pressure P shown in FIG. 25 is represented by the vertical axis. The pump control unit 23D determines the pump discharge pressure P by using the angle and discharge pressure correspondence table information. In this case, there is not the nozzle height detection unit 22, and the rotation angle Mθ detected by the rotation angle sensor 14a is inputted to the pump control unit 23D. The pump control unit 23D determines the pump discharge pressure P from the arm angle θ corresponding to the inputted rotation angle Mθ by using the angle and discharge pressure correspondence table information.

A control (referred to as a constant control), in which the injection amount of the washer fluid injected from the nozzle 13 is constant regardless of the height position of the nozzle 13, is also performed when the washer switch 32 is turned on.

In general, when the washer switch 32 is turned on, the pump 16 is operated and the washer fluid is injected from the nozzle 13. At the same time, the arm 11 is reciprocally driven by the wiper motor 14, and the wiper blade 12 reciprocates on the outer surface of the glass 2 for a predetermined number of times (for example, three times). The washer fluid is injected during the three reciprocations.

In the present embodiment, when the blade 12 reciprocates three times, the pump control unit 23D performs the above-described constant control by using the motor control signal from the motor control unit 21 and the nozzle height H from the nozzle height detection unit 22. That is, the pump control unit 23D controls the pump discharge pressure P to be higher when the nozzle height H is high (see FIG. 22A) than when the nozzle height H is low (see FIG. 22B) so that the injection amount of the washer fluid injected from the nozzle 13 is constant regardless of the nozzle height H.

### Operation of Third Embodiment

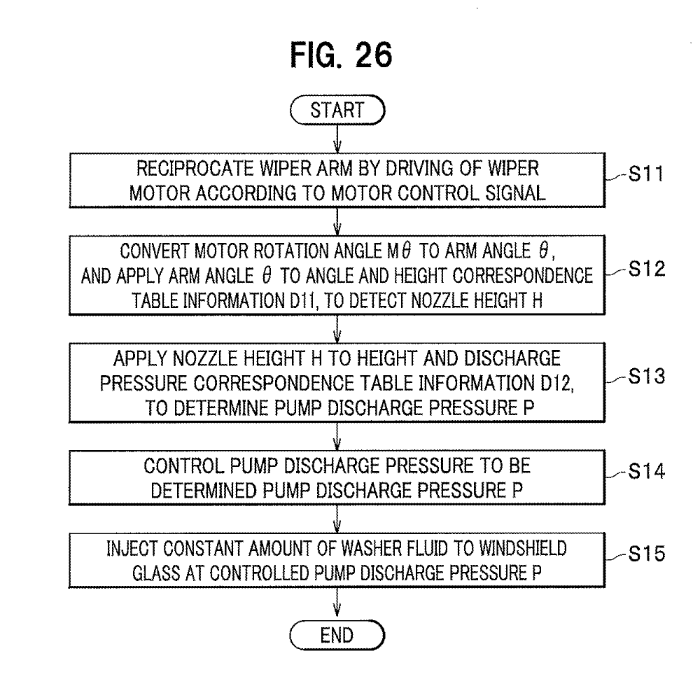

Next, control of the discharge pressure of the washer pump 16 by the control unit 19B will be described with reference to a flowchart shown in FIG. 26. In Step S11, when the wiper switch 31 is turned on, the motor control unit 21 reciprocates the wiper arm 11 by rotating the wiper motor 14 while alternately switching the normal rotation and reverse rotation by the motor control signal. In this case, the wiper blade 12 and the washer nozzle 13, which are attached to the arm 11, also reciprocate together with the arm 11. Further, it is assumed that the washer switch 32 is turned on, and the pump 16 is operated so that the washer fluid is injected from the nozzle 13.

Note that, it may be assumed that the washer switch 32 is turned on, and the washer fluid is injected from the nozzle 13, and at the same time, the arm 11 is reciprocally driven by the motor 14, and the blade 12 reciprocates on the outer surface of the glass 2 for a predetermined number of times, while the washer fluid is injected.

When the arm 11 reciprocates, the nozzle height detection unit 22 converts the rotation angle Mθ, which is detected by the rotation angle sensor 14a, of the wiper motor 14 to the arm angle θ, and applies the converted arm angle θ to the table information D11 (FIG. 24), to detect the nozzle height H, in Step S12.

For example, as shown in FIG. 22A, during forward movement of the arm 11, when the position of the injection port of the nozzle 13 is Lk, the variation height thereof is Hk. In this case, the nozzle height H1k is detected by adding the variation height Hk to the base height H1. Meanwhile, as shown in FIG. 22B, during backward movement of the arm 11, when the position of the injection port of the nozzle 13 is Lc, the variation height thereof is Hc. In this case, the nozzle height H1c is detected by adding the variation height Hc to the base height H1. Here, it is assumed that the nozzle height H1k shown in FIG. 22A is detected. The nozzle height H1k is inputted to the pump control unit 23D.

Next, in Step S13, the pump control unit 23D applies the inputted nozzle height H1k to the height and discharge pressure correspondence table information D12 (FIG. 25), to determine the pump discharge pressure P1k. Then, in Step S14, the pump control unit 23D controls the discharge pressure of the pump 16 to be the determined pump discharge pressure P1k by the pump control signal.

By this control, the pump 16 sucks the washer fluid from the tank 15 and discharges it to the pipe 18 at the controlled discharge pressure P1k, in Step S15. The washer fluid discharged to the pipe 18 is injected from the nozzle 13 to the glass 2 at the constant injection amount of, for example, 1.5 cc/sec.

Note that, the wiper arm 11 may be configured to reciprocate in a vertical direction between an upper end portion and a lower end portion of the glass 2 by a vertical reciprocating mechanism (not shown) including the wiper motor 14. In this case, the wiper blade 12 and the washer nozzle 13 also reciprocate together with the arm 11.

### Effects of Third Embodiment

The above-described washer injector 10B of the third embodiment includes the wiper blade 12 for wiping the windshield glass 2 provided in the vehicle 1, the wiper arm 11 for supporting the wiper blade 12, the wiper motor 14 as a drive mechanism for displacing the wiper arm 11 at least in the vertical direction, the washer nozzle 13 for injecting the washer fluid to the windshield glass 2, the washer pump 16 for supplying the washer fluid to the washer nozzle 13, and the control unit 19B as a control means for controlling the discharge pressure of the washer pump 16.

The third embodiment is characterized in that the nozzle 13 is provided on the blade 12 or the arm 11, and the control unit 19B controls the discharge pressure of the pump 16 to be higher when the position of the arm 11 is high than when the position of the arm 11 is low.

With this configuration, it is possible to increase the discharge pressure of the pump 16 as the height of the nozzle 13 is increased. Therefore, a predetermined amount of washer fluid can be injected regardless of the height position of the nozzle 13 provided on the arm 11. This makes it possible to improve a wiping effect of the glass 2 even when the nozzle 13 is in a high position.

Further, it is possible to avoid an increase and a decrease of the washer fluid due to the height position of the nozzle 13, by increasing the discharge pressure of the pump 16 as the height of the nozzle 13 is increased. Therefore, it is possible to reduce or prevent the wiping performance degradation of the glass 2 and unnecessary consumption of the washer fluid.

Further, when the control unit 19B controls the discharge pressure of the washer pump 16 to be higher when the position of the wiper arm 11 is high than when the position is low, the control unit 19B controls an injection amount of the washer fluid, which is injected from the washer nozzle 13, to be a constant amount in the same direction as the reciprocating movement of the wiper arm 11.

With this configuration, it is possible to allow the injection amount of the washer fluid to be the constant amount regardless of the height of the washer nozzle 13. Therefore, it is possible to reduce or prevent unnecessary consumption of the washer fluid while improving the wiping performance of the glass 2, by defining the constant injection amount of the washer fluid as a minimum amount required for properly wiping the glass 2.

### Configuration of Fourth Embodiment

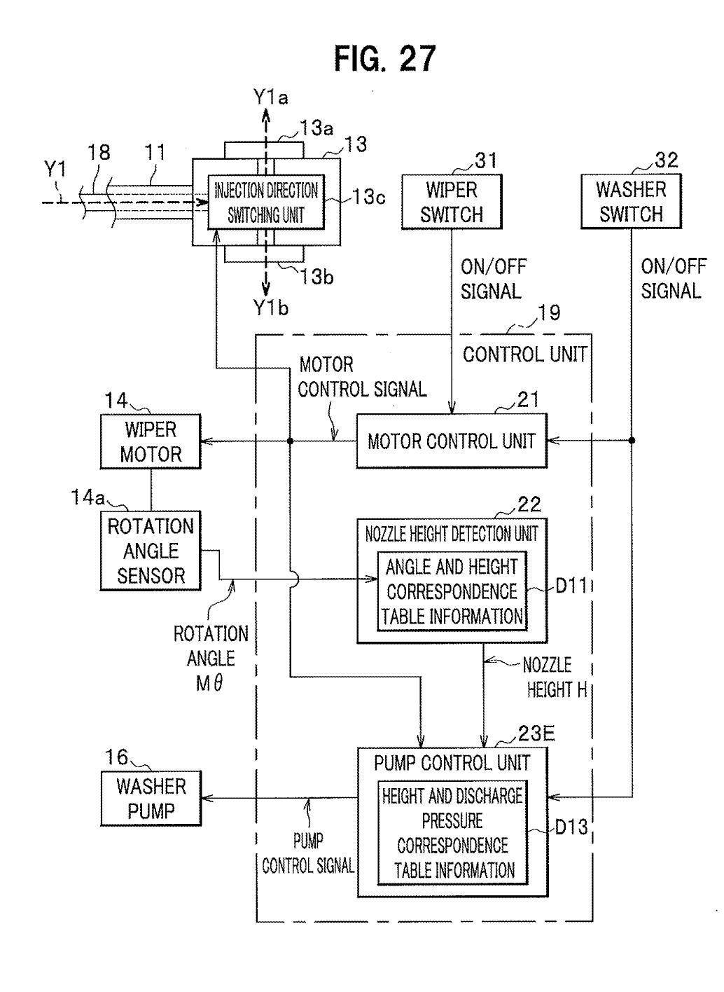

FIG. 27 is a block diagram showing a control unit of a washer injector according to a fourth embodiment of the present invention. Note that, in a control unit 19C shown in FIG. 27, the same components as the control unit 19B shown in FIG. 23 of the third embodiment are denoted by the same reference numerals, and description thereof will be omitted.

The control unit 19C shown in FIG. 27 differs from the control unit 19B of the third embodiment in that a pump control unit 23E controls the discharge pressure of the washer pump 16 (referred to as a discharge pressure control) to be higher during the forward movement of the wiper arm 11 than during the backward movement of the wiper arm 11.

Meanwhile, in the reciprocating movement of the arm 11, the forward side nozzle 13a injects the washer fluid upward during the forward movement, and the backward side nozzle 13b injects the washer fluid downward during the backward movement. Therefore, when it is assumed that the pump discharge pressure P is the same in both the forward and the backward movements of the arm 11, the injection amount of the washer fluid is smaller during the forward movement than during the backward movement, or it is not possible to inject the washer fluid to a position required for wiping the forward side of the windshield glass 2. Therefore, during the forward movement, it causes a problem such as wiping performance degradation of the glass 2 in some cases.

When the pump control unit 23E performs the discharge pressure control, it is possible to inject a proper amount of washer fluid to a proper position where the wiping performance of the glass 2 is not degraded even during the forward movement. In this case, in the backward side nozzle 13b during the backward movement at the same height as the forward movement, the pump discharge pressure P is lower than that during the forward movement, however, the washer fluid is injected downward, and thus it is possible to ensure the injection amount of washer fluid required for wiping the glass 2 and to inject the washer fluid to the position required for wiping the glass 2.

As for the discharge pressure control, the pump control unit 23E includes height and discharge pressure correspondence table information (also referred to as table information) D13, and controls the discharge pressure of the pump 16 as described below, by using the motor control signal of the motor control unit 21 in addition to the nozzle height H from the nozzle height detection unit 22.

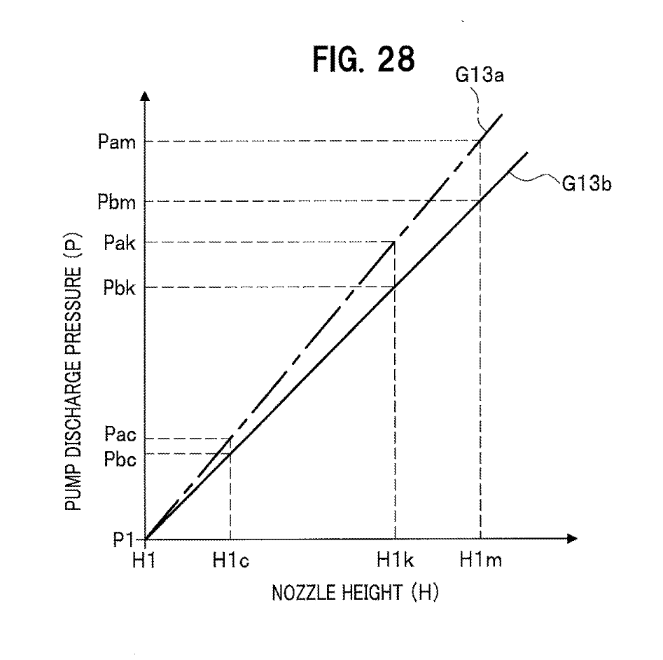

The height and discharge pressure correspondence table information D13 is a correspondence relationship, which is represented by data values, between the nozzle height H and the pump discharge pressure P in a height and discharge pressure correspondence map (also referred to as a map) shown by two graph lines G13a and G13b in FIG. 28. In the map shown in FIG. 28, the nozzle height H is represented by the horizontal axis as H1 (minimum height) to H1m (maximum height) and the pump discharge pressure P is represented by the vertical axis as P1 (minimum discharge pressure) to Pbc, Pac, Pbk, Pak, Pbm, Pam (maximum discharge pressure) in ascending order.

The graph line G13a shown in FIG. 28 represents a relationship between the nozzle height H1 to H1m and the pump discharge pressure P1, Pac, Pak, Pam during the forward movement of the arm 11. This relationship represents the discharge pressure P1, Pac, Pak, Pam of the pump 16 during injection of the washer fluid from the forward side nozzle 13a, when the nozzle height is H1 to H1m.

The graph line G13b represents a relationship between the nozzle height H1 to H1m and the pump discharge pressure P1, Pbc, Pbk, Pbm during the backward movement of the arm 11. This relationship represents the discharge pressure P1, Pbc, Pbk, Pbm of the pump 16 during injection of the washer fluid from the backward side nozzle 13b, when the nozzle height is H1 to H1m. Here, the pump discharge pressure P during the forward movement is referred to as a forward side pump discharge pressure Pa, and the pump discharge pressure P during the backward movement is referred to as a backward side pump discharge pressure Pb.

As can be seen from the graph lines G13a, G13b, the forward side pump discharge pressures Pac, Pak, Pam are respectively higher than the backward side pump discharge pressures Pbc, Pbk, Pbm at the nozzle height H1 to H1m. In this manner, it is determined such that, at the same nozzle height H, the injection amount of the washer fluid injected from the forward side nozzle 13a during the forward movement is larger than the injection amount of the washer fluid injected from the backward side nozzle 13b during the backward movement.

For example, it is assumed that a slope of the graph line 13b during the backward movement is “1”, and a slope of the graph line 13a during the forward movement is “1.2”. Further, in this case, it is assumed that the injection amount of the washer fluid injected from the backward side nozzle 13b is constant at 1.5 cc/sec, in a relationship between the nozzle height H1 to H1m and the backward side pump discharge pressure P1, Pbc, Pbk, Pbm, which is shown by the graph line G13b during the backward movement. In this case, the injection amount of the washer fluid injected from the forward side nozzle 13a is constant at 1.8 cc/sec {=(1.5 cc/sec)×1.2} larger than 1.5 cc/sec, in a relationship between the nozzle height H1 to H1m and the forward side pump discharge pressure P1, Pac, Pak, Pam, which is shown by the graph line G13a during the forward movement.

Returning to FIG. 27, the pump control unit 23E detects the normal rotation control or the reverse rotation control of the motor control signal from the motor control unit 21. When the detected result is the normal rotation control, the pump control unit 23E determines that the arm 11 is moving forward, and selects to refer to the relationship between the nozzle height H and the forward side pump discharge pressure Pa, which is shown by the graph line G13a (FIG. 28), from the table information D13.

Then, as with the third embodiment, the pump control unit 23E applies the nozzle height H detected by the nozzle height detection unit 22 to the selected relationship of the graph line G13a in the table information D13, to determine the forward side pump discharge pressure Pa. For example, when the nozzle height H is H1k shown in FIG. 28, the pump discharge pressure Pak is obtained through the graph line G13a. Then, the pump control unit 23E controls the discharge pressure of the pump 16 to be the obtained forward side pump discharge pressure Pak.

Meanwhile, when the reverse rotation control is detected from the motor control signal, the pump control unit 23E determines that the arm 11 is moving backward, and selects to refer to the relationship between the nozzle height H and the backward side pump discharge pressure Pb, which is shown by the graph line G13b, from the table information D13.

Then, the pump control unit 23E applies the nozzle height H detected by the nozzle height detection unit 22 to the selected relationship of the graph line G13b in the table information D13, to determine the backward side pump discharge pressure Pb. For example, when the nozzle height H is H1c shown in FIG. 28, the pump discharge pressure Pbc is obtained through the graph line G13b. The pump control unit 23E controls the discharge pressure of the pump 16 to be the obtained backward side pump discharge pressure Pbc.

### Operation of Fourth Embodiment

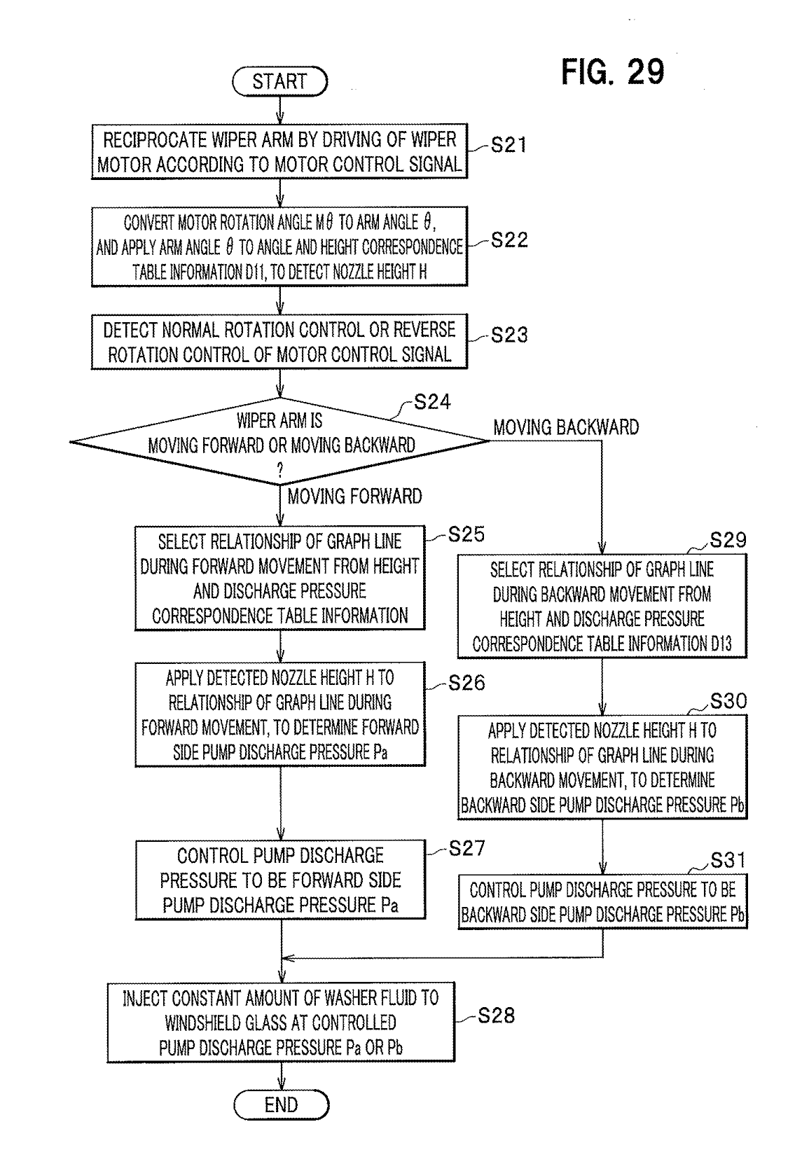

Next, control of the discharge pressure of the washer pump 16 by the control unit 19C will be described with reference to a flowchart shown in FIG. 29. Note that, in the flowchart shown in FIG. 29, description of the same contents as the flowchart shown in FIG. 26 of the third embodiment will be omitted.

In Step S21, as with the above-described Step S11 (FIG. 26), the arm 11 reciprocates together with the blade 12 and the nozzle 13 by reciprocal driving of the motor 14 according to the motor control signal of the motor control unit 21. In this case, it is assumed that the washer fluid is injected from the nozzle 13.

When the arm 11 reciprocates, as with the above-described Step S12 (FIG. 26), the nozzle height detection unit 22 detects the nozzle height H in Step S22. Here, it is assumed that the nozzle height H1k or H1c (see FIG. 22A or FIG. 22B) is detected and outputted to the pump control unit 23E.

Next, in Step S23, the pump control unit 23E detects the normal rotation control or the reverse rotation control of the motor control signal from the motor control unit 21, and in Step S24, determines whether the arm 11 is moving forward or moving backward. When the arm 11 is moving forward by the normal rotation control, it proceeds to Step S25, and when the arm 11 is moving backward by the reverse control, it proceeds to Step S29.

When the arm 11 is moving forward in Step S25, the pump control unit 23E selects the relationship of the graph line G13a (see FIG. 28) during the forward movement from the table information D13.

Next, in Step S26, the pump control unit 23E applies the nozzle height H1k detected in the above Step S22 to the relationship, which is selected in the above Step S25, of the graph line 13Ga shown in FIG. 28 during the forward movement, to determine the forward side pump discharge pressure Pak.

Next, in Step S27, the pump control unit 23E controls the discharge pressure of the pump 16 to be the forward side pump discharge pressure Pak obtained in the above Step S26.

By this control, in Step S28, the pump 16 sucks the washer fluid from the tank 15 and discharges it to the pipe 18 at the controlled forward side pump discharge pressure Pak. The washer fluid discharged to the pipe 18 is injected from the forward side nozzle 13a to the windshield glass 2 at the constant amount of, for example, 1.8 cc/sec.

Meanwhile, when it is determined that the arm 11 is moving backward in the above Step S24, the pump control unit 23E selects the relationship of the graph line G13b (FIG. 28) during the backward movement from the table information D13, in Step S29.

Next, in Step S30, the pump control unit 23E applies the nozzle height H1c detected in the above Step S22 to the relationship, which is selected in the above Step S29, of the graph line 13Gb (FIG. 28) during the backward movement, to determine the backward side pump discharge pressure Pbc.

Next, in Step S31, the pump control unit 23E controls the discharge pressure of the pump 16 to be the backward side pump discharge pressure Pbc obtained in the above Step S30.

By this control, in Step S28, the pump 16 sucks the washer fluid from the tank 15 and discharges it to the pipe 18 at the controlled backward side pump discharge pressure Pbc, and thus the washer fluid is injected from the backward side nozzle 13b to the windshield glass 2 at the constant amount of, for example, 1.5 cc/sec.

### Effects of Fourth Embodiment

In the above-described washer injector 10B of the fourth embodiment, the washer nozzle 13 includes the forward side nozzle 13a for injecting the washer fluid during the forward movement of the wiper arm 11, and the backward side nozzle 13b for injecting the washer fluid during the backward movement of the wiper arm 11. Then, the control unit 19C which is a control means controls the discharge pressure of the washer pump 16 to be higher during the forward movement of the arm 11 than during the backward movement thereof.

With this configuration, during the forward movement of the arm 11, the forward side nozzle 13a injects the washer fluid upward, however, since the discharge pressure of the pump 16 is increased to be higher than that during the backward movement, it is possible to inject the proper injection amount of washer fluid to the proper position where the wiping performance of the glass 2 is not degraded. This makes it possible to improve the wiping effect of the glass 2 even during the forward movement of the arm 11.

Further, the discharge pressure is lower during the backward movement of the arm 11 than during the forward movement thereof, however, since the washer fluid is injected downward, it is possible to inject the required amount of washer fluid to the position where the wiping performance is not degraded. Therefore, it is possible to reduce or prevent the wiping performance degradation during the forward movement and unnecessary consumption of the washer fluid during the backward movement.

### Configuration and Operation of Fifth Embodiment

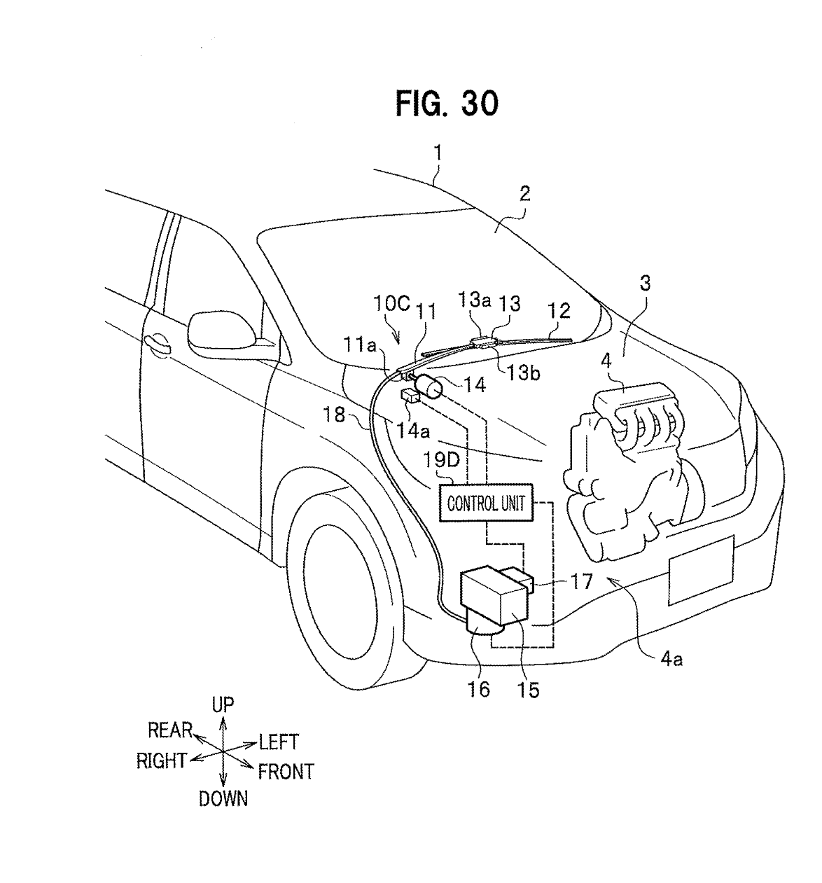

FIG. 30 is a perspective view of a vehicle equipped with a washer injector according to a fifth embodiment of the present invention. As shown in FIG. 30, a washer injector 10C of the vehicle 1 differs from the washer injector 10B (FIG. 21) of the third embodiment in that a viscosity sensor 17 is provided adjacent the washer tank 15, and a control unit 19D controls the discharge pressure of the pump 16 by using the nozzle height H and the viscosity [Pa·s] of the washer fluid detected by the viscosity sensor 17. Note that, the viscosity sensor 17 is a detection unit described in claims, and is also simply referred to as a sensor 17.

The viscosity of the washer fluid varies depending on the components thereof. Further, the viscosity of the washer fluid varies depending on the fluid temperature, and the washer fluid is difficult to flow when the viscosity thereof is increased as the temperature is reduced, while the washer fluid is easy to flow when the viscosity thereof is reduced as the temperature is increased. When the washer fluid is sucked from the tank 15 and injected from the nozzle 13 through the pipe 18 by the pump 16, if the viscosity is high, the washer fluid is difficult to flow through the pipe 18 and the like, and is difficult to be injected from the nozzle 13. In this case, the injection amount of the washer fluid is reduced, or the washer fluid is not injected to the position required for wiping the glass 2. Therefore, it causes a problem such as wiping performance degradation in some cases.

Therefore, in the fifth embodiment, by detecting the viscosity of the washer fluid in the tank 15 by the viscosity sensor 17, the control unit 19D controls the discharge pressure of the pump 16 to be higher when the detected viscosity is high than when the detected viscosity is low. Note that, the viscosity sensor 17 may detect the components of the washer fluid, and determine the viscosity from the correspondence relationship between viscosity change and temperature change associated with the components.

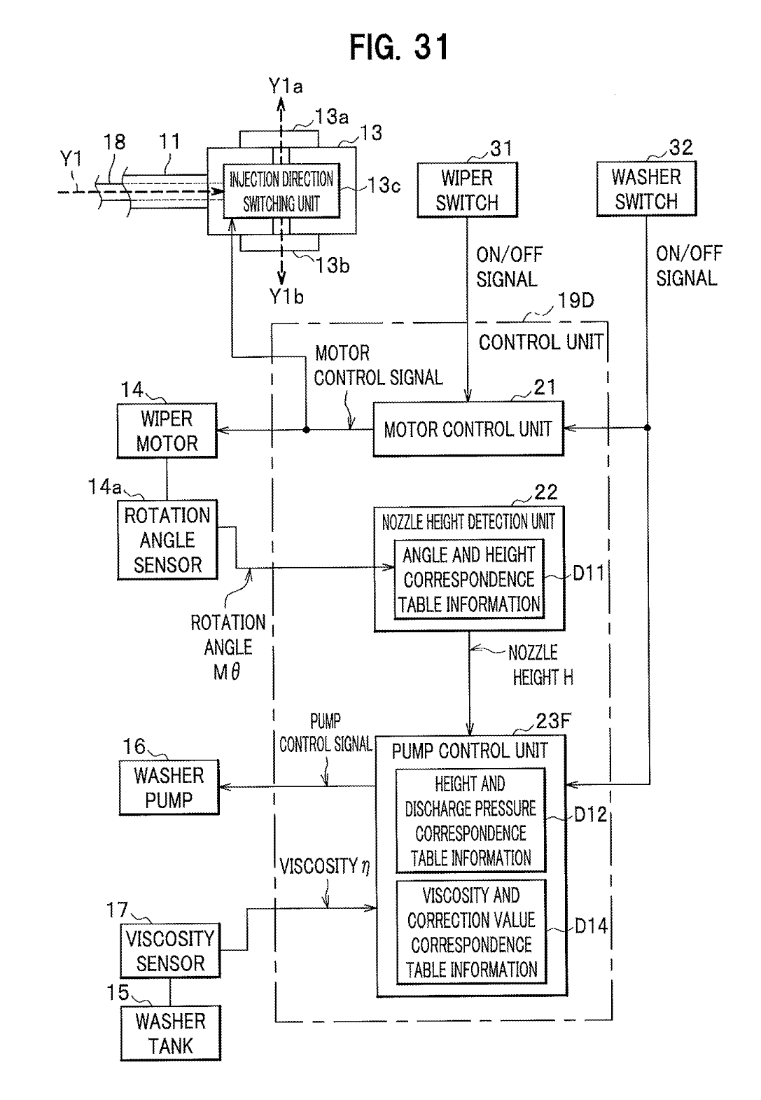

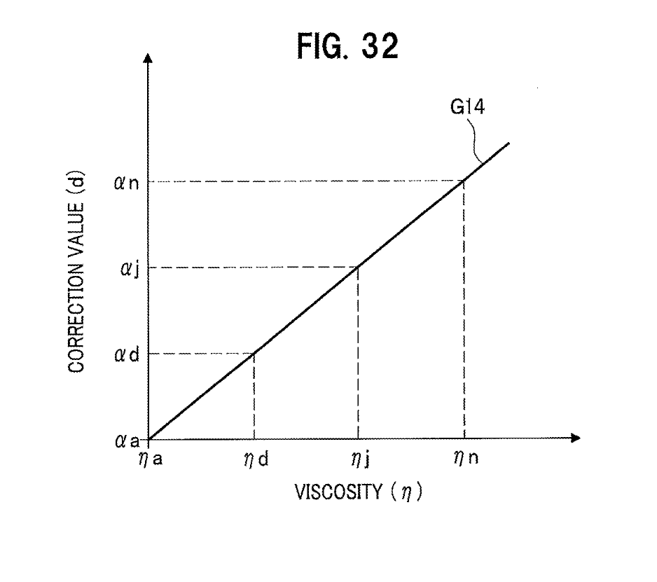

The control unit 19D differs from the control unit 19B (FIG. 23) of the third embodiment in that a pump control unit 23F shown in FIG. 31 determines a correction value α (FIG. 32) from the viscosity η detected by the sensor 17, and corrects the pump discharge pressure P (see FIG. 25) by the correction value α. The pump control unit 23F further includes viscosity and correction value correspondence table information (also referred to as table information) D14.

The viscosity and correction value correspondence table information D14 is a correspondence relationship, which is represented by data values, between the viscosity η of the washer fluid and the correction value α in a viscosity and correction value map (also referred to as a map) shown by a graph line G14 in FIG. 32. In the map shown in FIG. 32, the viscosity 11 is represented by the horizontal axis as ηa to ηd, ηj, ηn in ascending order and the correction value α is represented by the vertical axis as αa to αd, αj, an in ascending order.

The pump control unit 23F applies the nozzle height H to the table information D12, to determine the pump discharge pressure P. Further, the pump control unit 23F applies the viscosity η of the washer fluid detected by the sensor 17 to the table information D14, to determine the correction value α, and determines a corrected pump discharge pressure Pη (not shown) by multiplying the pump discharge pressure P, which is determined above, by the correction value α. Then, the pump control unit 23F controls the discharge pressure of the pump 16 to be the corrected pump discharge pressure Pη by the pump control signal including information of the corrected pump discharge pressure Pη.

Here, it is assumed that the viscosity ηj shown in FIG. 32 is a standard viscosity of the washer fluid, and the correction value αj corresponding to the viscosity ηj is “1”. In this case, it is assumed that the correction value an corresponding to the viscosity ηn, which is higher than the standard viscosity ηj and is difficult to flow, is “1.3”, and the correction value ad corresponding to the viscosity ηd, which is lower than the standard viscosity ηj and is easy to flow, is “0.8”.

In this case, when the viscosity sensor 17 detects the viscosity ηn, the pump control unit 23F applies the viscosity ηn to the table information D14, to determine the correction value αn=“1.3”. Further, the pump control unit 23F multiplies the pump discharge pressure (for example, P1k shown in FIG. 25), which is determined by applying the nozzle height H to the table information D12, by the correction value “1.3”, to determine the corrected pump discharge pressure Pη=“P1k×1.3”. Then, the pump control unit 23F controls the discharge pressure of the pump 16 to be the corrected pump discharge pressure “P1k×1.3”.

By this control, the discharge pressure of the pump 16 is increased from “P1k” to “P1k×1.3”. Therefore, even when the viscosity η of the washer fluid is the viscosity ηn, which is higher than the standard viscosity ηj and is difficult to flow, it is possible to suck the washer fluid from the tank 15 and properly inject it from the nozzle 13 through the pipe 18 by the pump 16.

Meanwhile, it is assumed that the viscosity η of the washer fluid in the tank 15 is the viscosity ηd, which is lower than the standard viscosity ηj (FIG. 32), and in this case, the viscosity sensor 17 detects the viscosity ηd. The pump control unit 23F applies the viscosity ηd to the table information D14, to determine the correction value αn=“0.8”. Further, the pump control unit 23F multiplies the pump discharge pressure (for example, P1k), which is determined by applying the nozzle height H to the table information D12, by the correction value “0.8”, to determine the corrected pump discharge pressure Pη=“P1k×0.8”. Then, the pump control unit 23F controls the discharge pressure of the pump 16 to be the corrected pump discharge pressure “P1k×0.8”.

By this control, the discharge pressure of the pump 16 is reduced from “P1k” to “P1k×0.8”. In this case, since the viscosity ηd of the washer fluid is lower than the standard viscosity ηj and is easy to flow, the washer fluid is properly injected from the nozzle 13 through the pipe 18 even when the discharge pressure of the pump 16 is reduced.

### Effects of Fifth Embodiment

The above-described washer injector 10C of the fifth embodiment includes the viscosity sensor 17 as a detection means for detecting the viscosity of the washer fluid in the washer tank 15, and the pump control unit 23F controls the discharge pressure of the washer pump 16 to be higher when the viscosity η detected by the viscosity sensor 17 is high than when the viscosity η is low.

With this configuration, it is possible to optimize the pump discharge pressure P (corrected pump discharge pressure Pη) according to a level of the viscosity of the washer fluid. That is, when the viscosity of the washer fluid is high, the washer fluid is difficult to flow, however, it is possible to properly inject the washer fluid to the windshield glass 2 by increasing the discharge pressure of the pump 16. This makes it possible to reduce or prevent the wiping performance degradation.

Meanwhile, when the viscosity of the washer fluid is low, the washer fluid properly flows from the tank 15 to the nozzle 13 to be injected even when the discharge pressure of the pump 16 is low. Therefore, when the viscosity of the washer fluid is low, by reducing the discharge pressure of the pump 16, it is possible to reduce or prevent unnecessary consumption of the washer fluid, and further it is possible to reduce driving electric power of the pump 16.

The control of the pump discharge pressure P by the pump control unit 23F of the washer injector 10C of the fifth embodiment can be similarly applied to the pump control unit 23E of the fourth embodiment. In this case, the pump discharge pressure P only have to be corrected by multiplying the forward side pump discharge pressure Pa or the backward side pump discharge pressure Pb by the viscosity η of the washer fluid detected by the sensor 17.

### Modification 4

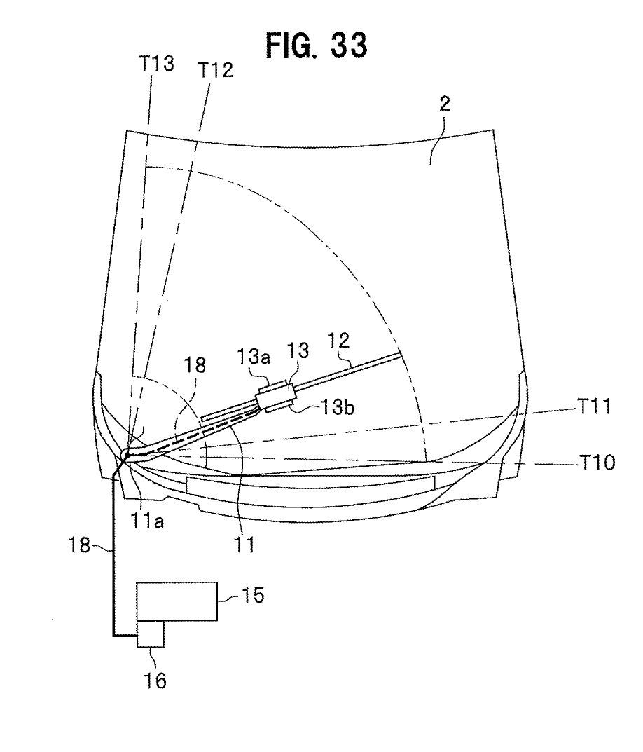

As shown in FIG. 33, the wiper arm 11 reciprocates together with the wiper blade 12 and the washer nozzle 13, between a start position T10 which is a substantially horizontal position and an end position T13 which is a substantially vertical position. In this case, the washer fluid is injected from the forward side nozzle 13a or the backward side nozzle 13b. However, when the washer fluid is injected at the end position T13 during the forward movement of the arm 11, the washer fluid is wasted because the washer fluid flies out to the outside of the windshield glass 2.

In addition, even between the end position T13 and an end vicinity position T12 near the end position T13, a length of the glass 2 is short, and most of the washer fluid flies out to the outside of the windshield glass 2. Therefore, when the washer fluid is injected in a range outside the end vicinity position T12 in the same manner as a range inside the end vicinity position T12, the washer fluid is wasted. The washer fluid is also wasted between the start position T10 and a start vicinity position T11 near the start position T10.

Therefore, in the pump control unit 23D shown in FIG. 23, the pump control unit 23E shown in FIG. 27, and the pump control unit 23F shown in FIG. 31, the pump discharge pressure P is controlled to be low according to the arm angle θ obtained by the nozzle height detection unit 22 as described below. Here, the pump control unit 23D shown in FIG. 23 will be described as a representative example. In addition, the forward movement in the reciprocating movement of the arm 11 will be described as a representative example.

During the forward movement of the arm 11, the pump control unit 23D detects the position of the arm 11 from the arm angle θ obtained by the nozzle height detection unit 22. The pump discharge pressure P is controlled to be gradually reduced from when the detected position of the arm 11 reaches the end vicinity position T12, so as to be “zero” when the position reaches the end position T13. Note that, by controlling the pump discharge pressure P not to be “zero” but to be a value close to “zero”, start-up time of the injection of the washer fluid in the next backward movement may be reduced.

According to this control, the washer fluid injected from the forward side nozzle 13a is gradually reduced from the end vicinity position T12, and is not injected at the end position T13.

In more detail, the end vicinity position T12 is ideally a position where the washer fluid injected from the forward side nozzle 13a reaches the end position T13. Therefore, in the range outside the end vicinity position T12, the pump control unit 23D preferably controls the pump discharge pressure P so that the injection amount is reduced while the washer fluid reaches the end position T13 in accordance with the forward movement of the forward side nozzle 13a.

By such a control, it is possible to properly wipe the windshield glass 2 while reducing or preventing the waste of the washer fluid.

In addition, the pump control unit 23D may control the pump discharge pressure P to be “zero” when the arm angle θ reaches the end position T13 during the forward movement of the arm 11.

### DESCRIPTION OF NUMERALS

1: vehicle
2: windshield glass
4: engine
4a: engine compartment
10, 10A, 10B, 10C: washer injector
11: wiper arm
12: wiper blade
13: washer nozzle
13a: forward side nozzle
13b: backward side nozzle
13c: injection direction switching unit
14: wiper motor (motor of drive mechanism)
14a: rotation angle sensor
15: washer tank
16: washer pump
17: viscosity sensor
18: pipe
19, 19A, 19B, 19C, 19D: control unit (control means)
21: motor control unit
22: nozzle height detection unit
23, 23B, 23C, 23D, 23E, 23F: pump control unit
23a: holding unit
41: fluid temperature sensor (detection means)
42: ambient temperature sensor (obtaining means)
43: flow path vicinity temperature sensor (obtaining means)
44: engine temperature sensor (obtaining means)

1. A washer injector comprising:
a washer nozzle for injecting a washer fluid to a windshield glass of a vehicle;
a washer pump for supplying the washer fluid to the washer nozzle;
a detection unit for detecting a fluid temperature which is a temperature of the washer fluid; and
a control unit for controlling a discharge pressure of the washer pump,
wherein the control unit controls the discharge pressure of the washer pump to be higher when the fluid temperature detected by the detection unit is low than when the fluid temperature is high.

2. The washer injector according to claim 1,
wherein when the fluid temperature is equal to or lower than a predetermined threshold temperature, the control unit controls the discharge pressure of the washer pump to be higher than a discharge pressure at a time when the fluid temperature is higher than the threshold temperature.

3. A washer injector comprising:
a washer nozzle for injecting a washer fluid to a windshield glass of a vehicle;
a washer pump for supplying the washer fluid to the washer nozzle;
an obtaining unit for obtaining any one of an ambient temperature outside the vehicle, an engine temperature which is a temperature of an engine in an engine compartment of the vehicle, and a temperature in a vicinity of a flow path to the washer nozzle from a washer tank; and
a control unit for controlling a discharge pressure of the washer pump,
wherein the control unit controls the discharge pressure of the washer pump to be higher when the temperature obtained by the obtaining unit is low than when the temperature is high.

4. The washer injector according to claim 3,
wherein the obtaining unit obtains the ambient temperature, and
wherein when the obtained ambient temperature is equal to or lower than a specific ambient temperature which is set in advance, the control unit controls the discharge pressure of the washer pump to be higher than a discharge pressure at a time when the ambient temperature is higher than the specific ambient temperature.

5. The washer injector according to claim 4,
wherein the obtaining unit obtains the ambient temperature and the engine temperature, and
wherein even when the obtained ambient temperature is equal to or lower than the specific ambient temperature, when the obtained engine temperature is equal to or higher than a specific engine temperature which is set in advance, the control unit controls the discharge pressure of the washer pump to be lower than a discharge pressure at a time when the engine temperature is lower than the specific engine temperature.

6. The washer injector according to claim 4,
wherein the obtaining unit obtains the ambient temperature and the temperature in the vicinity of the flow path, and
wherein even when the obtained ambient temperature is equal to or lower than the specific ambient temperature, when the obtained temperature in the vicinity of the flow path is equal to or higher than a specific preset temperature in the vicinity of the flow path, the control unit controls the discharge pressure of the washer pump to be lower than a discharge pressure at a time when the temperature in the vicinity of the flow path is lower than the specific preset temperature in the vicinity of the flow path.

7. The washer injector according to claim 1, further comprising
a component detection unit for detecting components contained in the washer fluid,
wherein, from a correspondence relationship between a viscosity and a temperature of the washer fluid containing components detected by the component detection unit, the control unit determines a viscosity of the washer fluid corresponding to a temperature detected during the detection, and corrects the discharge pressure of the washer pump to be a discharge pressure capable of discharging a required amount of washer fluid for properly wiping the windshield glass at a time of the determined viscosity.

8. A washer injector comprising:
a wiper blade for wiping a windshield glass provided in a vehicle;
a wiper arm for supporting the wiper blade;
a drive mechanism including a motor for displacing the wiper arm at least in a vertical direction;
a washer nozzle for injecting a washer fluid to the windshield glass;
a washer pump for supplying the washer fluid to the washer nozzle; and
a control unit for controlling a discharge pressure of the washer pump,
wherein the washer nozzle is provided on the wiper blade or the wiper arm, and
wherein the control unit controls the discharge pressure of the washer pump to be higher when a position of the wiper arm is high than when the position is low.

9. The washer injector according to claim 8,
wherein when the control unit controls the discharge pressure of the washer pump to be higher when the position of the wiper arm is high than when the position is low, the control unit controls an injection amount of the washer fluid, which is injected from the washer nozzle, to be a constant amount in the same direction as reciprocating movement of the wiper arm.

10. The washer injector according to claim 8,
wherein the washer nozzle comprises a forward side nozzle for injecting the washer fluid during forward movement of the wiper arm and a backward side nozzle for injecting the washer fluid during backward movement of the wiper arm, and
wherein the control unit controls the discharge pressure of the washer pump to be higher during the forward movement of the wiper arm than during the backward movement of the wiper arm.

11. The washer injector according to claim 8, further comprising
a detection unit for detecting viscosity of the washer fluid,
wherein the control unit controls the discharge pressure of the washer pump to be higher when the viscosity detected by the detection unit is high than when the viscosity is low.

12. The washer injector according to claim 8,
wherein the control unit controls the discharge pressure of the washer pump to be gradually reduced in a position range of the wiper arm just before the washer fluid injected from the washer nozzle flies out to the outside of the windshield glass.

13. The washer injector according to claim 8,
wherein the control unit controls the discharge pressure of the washer pump so that the washer fluid injected from the washer nozzle is stopped at a start position and an end position of reciprocating movement of the wiper arm.

14. The washer injector according to claim 3, further comprising
a component detection unit for detecting components contained in the washer fluid,
wherein, from a correspondence relationship between a viscosity and a temperature of the washer fluid containing components detected by the component detection unit, the control unit determines a viscosity of the washer fluid corresponding to a temperature detected during the detection, and corrects the discharge pressure of the washer pump to be a discharge pressure capable of discharging a required amount of washer fluid for properly wiping the windshield glass at a time of the determined viscosity.
